(19) United States
(12) Patent Application Publication
(10) Pub. No.: US 2026/0196740 A1
(43) Pub. Date: Jul. 9, 2026

(54) REFLECTARRAY ANTENNA ELEMENT WITH 2-BIT PHASE QUANTIZATION AND MINIMUM-SWITCH TOPOLOGY

(71) Applicant: UNIVERSITY OF NORTH TEXAS, Dallas, TX (US)

(72) Inventors: Hung LUYEN, Dallas, TX (US); Son VU, Dallas, TX (US)

(21) Appl. No.: 19/445,195

(22) Filed: Jan. 9, 2026

Related U.S. Application Data
(60) Provisional application No. 63/743,404, filed on Jan. 9, 2025.

(51) Int. Cl. H01Q 21/06; H01Q 9/04

(52) U.S. Cl. CPC H01Q 21/065; H01Q 9/0414; H01Q 9/0442; H01Q 9/045

(57) ABSTRACT

A reflectarray antenna element includes a first dielectric layer, a conductive ground layer mounted to the first dielectric layer and including an aperture formed therethrough, a second dielectric layer mounted to the conductive ground layer, a radiating patch layer mounted to the second dielectric layer, a delay line layer mounted to the first dielectric layer and comprising a first delay line connected to an open-circuit termination and a second delay line connected to a short-circuit termination, and a first switch and a second switch electrically connected to the first delay line and the second delay line. The first delay line and the second delay line are positioned to couple electromagnetically with the aperture, and each switch is switchable between an ON state and an OFF state.

### CROSS-REFERENCE TO RELATED APPLICATIONS

This application claims the benefit of U.S. Provisional Application No. 63/743,404, filed on Jan. 9, 2025, and entitled “REFLECTIVE PHASED-ARRAY ELEMENTS WITH 2-BIT PHASE QUANTIZATION AND MINIMUM-SWITCH TOPOLOGY”, which is incorporated herein by reference in its entirety for all purposes.

### STATEMENT REGARDING FEDERALLY SPONSORED RESEARCH

This invention was made with government support under Cooperative Agreement Number W911NF-23-2-0014 awarded by the Army Research Laboratory. The government has certain rights in the invention.

### TECHNICAL FIELD

The present disclosure relates generally to antenna systems and more particularly to reconfigurable reflectarray antennas configured for beam steering applications using phase-shifting elements with discrete phase quantization.

### BACKGROUND

Electrically reconfigurable reflectarray antennas (RRAs) with dynamic beam-steering capabilities have emerged as a promising solution for modern wireless communication and sensing systems, offering advantages such as rapid reconfiguration, design flexibility, ease of fabrication, and low cost. Reconfigurable reflectarray antennas are increasingly used as affordable alternatives to active phased array antennas for various wireless applications requiring beam scanning capability.

A conventional active phased array antenna includes an array of antennas in which a relative phase of signals feeding each antenna is varied such that an effective radiation pattern of the array is reinforced in a desired direction and suppressed in undesired directions to provide electronic steering of a beam. However, such conventional active phased array systems exhibit high complexity, high power consumption, and high cost. The solid-state technology at the heart of current phased array antenna technology has inherent limitations in power and heat handling capability due to generation of large amounts of heat. The cost of current phased array antenna technology is a major factor that limits application to expensive military systems.

A reflectarray antenna typically consists of an array of individual elements arranged on a flat or conformable surface and illuminated by a feed antenna. Each element is designed to reflect an incident wave with a specific phase shift to provide beam collimation over the array aperture to generate a high-gain pencil beam. By individually adjusting the phase of each array element, reflectarrays can control the direction of the main beam and perform beam scanning while maintaining a relatively simple, planar structure.

Ideally, reflectarray elements should be capable of producing any arbitrary phase shift between 0° and 360° for perfect phase correction. However, continuously adjusting the phase shift through voltage control poses significant challenges in terms of control circuitry complexity and voltage supply architecture. Moreover, achieving a full reconfigurable 0° to 360° phase range over a broad frequency range (e.g., fractional bandwidth larger than 10%) is technically challenging.

To address these limitations, discrete phase correction schemes have been widely adopted. These schemes quantize the full 0°to 360°phase range into a number of discrete phase shift values, simplifying the control circuitry while still enabling beam-steering functionality. Common phase quantization schemes include 1-, 2-, and 3-bit configurations, which are associated with quantization loss of about 3 dB, 0.6 dB, and 0.2 dB, respectively. The simplest scheme is 1-bit phase quantization, which uses only two phase states. However, 1-bit discretization results in a large phase error accumulated over the reflectarray aperture, reducing directivity by approximately 3.7 decibels (dB) compared to a perfectly collimated reflectarray.

Improving the phase quantization to 2-bit (four phase states: 0°, 90°, 180°, and 270°) helps recover approximately 3 dB of this directivity reduction, representing a significant performance improvement. Increasing the number of phase states beyond four yields only modest directivity increases of less than 0.7 dB. This modest increase is often canceled by higher losses due to additional switches and more complicated unit cell designs. Publications reveal that average phase shifter loss is approximately 1 dB per bit, meaning that adding one more bit generally increases overall system loss by 1 dB. Taking into account phase shifter loss, an array using 3-bit phase shifters provides only slightly higher directivity but lower realized gain compared to one using 2-bit phase shifters. Generally, a greater number of phase states will provide better beamforming performance, albeit at the expense of higher system complexity and increased implementation cost. It has been shown that a 2-bit phase correction scheme represents the most sensible choice, which performs very close to an ideal continuous phase correction scheme while keeping the complexity of the unit cells and control circuitry manageable.

In electronically reconfigurable reflectarray antennas, a large fraction of fabrication cost is due to switches such as PIN diodes or MEMS switches used for reconfiguration. Therefore, minimizing the number of switches while maintaining 2-bit phase quantization capability represents an important design objective.

Electronically tunable RRAs can generally be divided into two types based on the underlying phase-shifting mechanism. The first type provides continuous reflection-phase tuning by employing varactor diodes, graphene, or liquid crystal. While this approach allows for fine phase resolution, it necessitates more intricate biasing and control circuitry. The second type utilizes discrete phase states, realized through electronic switches such as PIN diodes or MEMS devices. These designs benefit from lower reflection loss and simplified control schemes. Although MEMS switches typically offer lower power consumption and superior linearity compared to PIN diodes, they are hindered by high actuation voltage requirements and reliability concerns. As a result, PIN-diode-based RRAs have gained significant traction due to their favorable balance between performance, system integration, and technological maturity.

Among phase quantization schemes, 1-bit RRAs remain the most prevalent due to their straightforward designs and ease of implementation. In this architecture, each unit cell provides two discrete phase states with a reflection-phase difference of 180°. Several 1-bit RRA unit cells using from two to four PIN diodes for reconfiguration and relying on the polarization rotation concept for achieving wideband operation have been reported. Alternatively, some designs leverage magnetoelectric (ME) dipole structures to achieve the same 180° phase shift with only a single PIN diode by switching between distinct resonance modes. Other 1-bit RRA designs are based on tunable resonator patches and delay-line mechanisms.

Compared to designs using 1-bit phase shift, RRAs that employ 2-bit phase quantization offer significantly better performance in terms of reduced peak sidelobe levels (SLLs), enhanced aperture efficiency, and improved beam-forming capabilities. However, achieving the four discrete phase states typically increases the number of PIN diodes per unit cell, thereby complicating the biasing network and introducing additional insertion loss. Some designs present 2-bit reflectarrays utilizing mixed polarization-rotation and non-polarization-rotation reflection modes with four hard-wired switches. Other designs employ dual-polarized unit cells based on the delay-line approach utilizing four PIN diodes to realize the four quantized phase states, achieving maximum aperture efficiencies of 40.6%. Some designs employ eight PIN diodes to implement a 2-bit dual polarized RRA, providing independent control of the two circular polarization (CP) senses, albeit with increased bias-line complexity. Other designs use four PIN diodes per unit cell to realize polarization-insensitive 2-bit RRAs with measured results showing two-dimensional beam steering over ±60° with high polarization purity and peak aperture efficiencies of 31.2%. These studies collectively underscore the trade-offs among diode count, polarization diversity, and bandwidth in 2-bit RRA designs, and motivate ongoing efforts to develop low-complexity, broadband unit cells that achieve efficient 2-bit phase quantization with minimal switching hardware.

In theory, the minimum number of single-pole single-throw (SPST) switches (e.g., PIN diodes) needed to realize four operating modes for 2-bit operation is two. However, most reconfigurable 2-bit reflectarray unit cells reported in the literature use more than 2 PIN diodes. Only a few studies have successfully implemented 2-bit operation using just two PIN diodes, which represent the minimum number of SPST switches required to realize four discrete phase states in a unit cell. These designs typically rely on tuning the resonant frequency of the unit cell structure and often offer a 2-bit phase shift over a narrow frequency range. One 2-bit unit cell operates at 5.98 GHz and employs a U-shaped resonator on the top layer along with two PIN diodes to achieve the desired phase quantization. However, the fabricated 12×12 reconfigurable reflectarray based on this unit cell yields a relatively low aperture efficiency of 7.3%. Another single-layer unit cell based on a folded-ground structure was proposed to reduce the number of dielectric substrate layers typically required in reconfigurable reflectarrays. The resulting phase-modulated (PM) antenna demonstrates beam steering up to ±60°, with a measured peak gain of 23.5 dBi and an aperture efficiency of 28.2%. However, these studies only characterized the beam-scanning performance of the reflectarray antennas at a single frequency point and did not report the operating bandwidths of the unit cells. Both studies characterized the beam-scanning performance of the reflectarray antennas at a single frequency point and did not report the operating bandwidths of the unit cells. A large-scale RRA with 2-bit phase resolution at Ka-band employed five metallic layers to realize the four phase states. The measured results show a peak gain of 29.2 dBi and an aperture efficiency of approximately 27.1% at 26.1 GHz. The antenna also supports beam scanning up to ±50° with a 3-dB gain reduction across the scanned angles in the H-plane, and from −50° to 30° in the E-plane at 26.1 GHz. The 2-bit bandwidth of the unit cell, defined by the criteria that the phase resolution exceeds 1.7 bits and the dominant reflection coefficients for all four modes remain above −2.0 dB, was reported as 6.5%. This marks an improvement over earlier designs. However, this enhanced phase bandwidth was achieved using a five-metal-layer structure, indicating potential for future improvements in reducing design complexity and implementation cost.

Accordingly, there remains a need for improved 2-bit reflectarray unit cell designs that extend operating bandwidth while maintaining minimum switch count, thereby reducing system complexity and cost while improving performance across wider frequency ranges. New designs for 2-bit reflectarray unit cells that extend the operating bandwidth while maintaining the minimum number of switches (e.g., two PIN diodes) are highly desirable.

### SUMMARY

In some embodiments, a reflectarray antenna element comprises: a first dielectric layer, a conductive ground layer mounted to the first dielectric layer and including an aperture formed therethrough, a second dielectric layer mounted to the conductive ground layer, a radiating patch layer mounted to the second dielectric layer, a delay line layer mounted to the first dielectric layer and comprising a first delay line connected to an open-circuit termination and a second delay line connected to a short-circuit termination, and a first switch and a second switch electrically connected to the first delay line and the second delay line. The first delay line and the second delay line are positioned to couple electromagnetically with the aperture, and each switch is switchable between an ON state and an OFF state.

In some embodiments, a reconfigurable reflectarray antenna system comprises: a feed antenna configured to generate an incident electromagnetic wave, a reflective array surface comprising a plurality of reflectarray antenna elements arranged in a two-dimensional array, where each reflectarray antenna element comprises a conductive ground layer including an aperture formed therethrough, dielectric layers mounted to the conductive ground layer, a radiating patch layer, a delay line layer comprising a first delay line connected to an open-circuit termination and a second delay line connected to a short-circuit termination, a first switch and a second switch electrically connected to the first delay line and the second delay line, and a control system operatively connected to the first switch and the second switch of each reflectarray antenna element and configured to independently control states thereof to provide a selected phase shift distribution across the reflective array surface. The delay lines are positioned to couple electromagnetically with the aperture.

In some embodiments, a method of operating a reconfigurable reflectarray antenna comprises: providing a reflective array surface comprising a plurality of reflectarray antenna elements, generating an incident electromagnetic wave using a feed antenna, for each reflectarray antenna element, determining a reflection phase shift based on a phase of the incident electromagnetic wave at the reflectarray antenna element and a desired outgoing phase to direct a main beam at a selected scan angle, quantizing the reflection phase shift into one of four discrete phase shift levels corresponding to four operating modes, setting states of the first switch and the second switch of each reflectarray antenna element based on the quantized phase shift level, and reflecting the incident electromagnetic wave from the reflective array surface to form a beam directed at the selected scan angle. Each reflectarray antenna element comprises a delay line layer with a first delay line connected to an open-circuit termination and a second delay line connected to a short-circuit termination, and a first switch and a second switch electrically connected to the first delay line and the second delay line.

These and other features will be more clearly understood from the following detailed description taken in conjunction with the accompanying drawings and claims.

### BRIEF DESCRIPTION OF THE DRAWINGS

For a detailed description of the aspects of the presently disclosed subject matter, reference will now be made to the accompanying drawings.

FIG. 1A illustrates a schematic diagram of a reconfigurable reflectarray antenna system showing a feed antenna illuminating a reflective array surface in accordance with an illustrative embodiment.

FIG. 1B illustrates phase quantization schemes including 1-bit, 2-bit, and 3-bit phase shift configurations showing discrete phase states in accordance with illustrative embodiments.

FIG. 2A is a three-dimensional perspective view of a unit cell structure showing stacked dielectric and conductive layers in accordance with an illustrative embodiment.

FIG. 2B is a side cross-sectional view of the unit cell structure of FIG. 2(a) showing layer thicknesses and materials.

FIG. 3A is a top plan view of a radiating patch layer showing a divided patch configuration with gaps in accordance with an illustrative embodiment.

FIG. 3B is a top plan view of a conductive ground layer showing an I-shaped aperture configuration in accordance with an illustrative embodiment.

FIG. 3C is a bottom plan view of a delay line layer showing switchable delay lines with PIN diodes and bias circuitry in accordance with an illustrative embodiment.

FIG. 4 is a graph comparing E-field distribution for different slot shapes and top radiating patches, showing modification from a straight slot to an I-shaped slot to achieve more uniform and linear E-field distribution along the aperture in accordance with an illustrative embodiment.

FIG. 5A is a three-dimensional schematic illustrating wave propagation from the top radiating patch, coupling through the aperture slot, and traveling along transmission lines located on the bottom layer in accordance with an illustrative embodiment.

FIG. 5B illustrates four distinct operating modes corresponding to the ON and OFF states of two PIN diodes which selectively connect an open-circuited and a short-circuited microstrip line in the delay-line configuration in accordance with an illustrative embodiment.

FIG. 6 illustrates simulated surface current distributions on the two delay lines of the proposed unit cell for the four distinct PIN diode switching states in accordance with an illustrative embodiment.

FIG. 7A is a three-dimensional view showing configuration of the reconfigurable reflectarray with feed horn antenna and dimensions indicated in accordance with an illustrative embodiment.

FIG. 7B is a top plan view showing a distribution pattern of discrete spatial phase shifters for a broadside beam direction (θ=0°, φ=0°) in accordance with an illustrative embodiment.

FIG. 7C is a top plan view showing a distribution pattern of discrete spatial phase shifters for a tilted beam direction (θ=15°, φ=0°) in accordance with an illustrative embodiment.

FIG. 8 is a diagram showing the control architecture used to reconfigure PIN diodes in the reconfigurable reflectarray, comprising D-type flip-flops, shift registers, and a row-select decoder with FPGA board in accordance with an illustrative embodiment.

FIG. 9 is a comparison table showing performance metrics of various 2-bit reflectarray designs including number of PIN diodes, element bandwidth, maximum gain, aperture efficiency, and scanning range.

FIG. 10A is a bottom plan view of the proposed unit cell showing a case where two bias lines cross over it in accordance with an illustrative embodiment.

FIGS. 10B and 10C are graphs showing simulated reflection coefficients Rₓₓ for the four operating modes including magnitude and phase responses in accordance with an illustrative embodiment.

FIG. 11A is a bottom plan view of the proposed unit cell showing a scenario where ten bias lines cross over it in accordance with an illustrative embodiment.

FIGS. 11B and 11C are graphs showing simulated reflection coefficients Rₓₓ for the four operating modes under a 10-bias-line configuration at oblique angles of 0 degrees in accordance with an illustrative embodiment.

FIGS. 12A and 12B are graphs showing simulated reflection coefficients Rₓₓ for the four operating modes under 2-bias-line and 10-bias-line configurations at oblique angles of 30 degrees in TE mode in accordance with an illustrative embodiment.

FIGS. 13A and 13B are graphs showing simulated reflection coefficients Rₓₓ for the four operating modes under 2-bias-line and 10-bias-line configurations at oblique angles of 30 degrees in TM mode in accordance with an illustrative embodiment.

FIG. 14 is a graph showing equivalent bit number N_{bit} of the proposed 2-bit unit cell under different scenarios, considering variations in the number of bias lines and the oblique angle of the incident wave in accordance with an illustrative embodiment.

FIG. 15A is a photograph showing a top surface view of a fabricated prototype in accordance with an illustrative embodiment.

FIG. 15B is a photograph showing a bottom surface view of the fabricated prototype in accordance with an illustrative embodiment.

FIG. 15C is a photograph showing a measurement setup for characterizing radiation patterns of the fabricated reflectarray antenna prototype inside a near-field spherical measurement system in an anechoic chamber in accordance with an illustrative embodiment.

FIG. 16A is a polar plot comparing measured and simulated co-polarized and cross-polarized radiation patterns in the E-plane for a beam direction of θ=0°, φ=0° at 5.8 GHz in accordance with an illustrative embodiment.

FIG. 16B is a polar plot comparing measured and simulated co-polarized and cross-polarized radiation patterns in the E-plane for a beam direction of θ=15°, φ=0° at 5.8 GHz in accordance with an illustrative embodiment.

FIG. 17A-17M are a series of polar plots showing measured co-polarized and cross-polarized radiation patterns at various frequencies including (a)-(f) E-plane patterns and (g)-(m) H-plane patterns at 5.5 GHz, 5.6 GHz, 5.7 GHz, 5.8 GHz, 5.9 GHz, and 6.0 GHz, respectively, with beam scan angles ranging from 0° to 60° in accordance with illustrative embodiments.

FIG. 18A is a graph showing measured realized gain versus frequency with different scan angles in the E-plane in accordance with an illustrative embodiment.

FIG. 18B is a graph showing measured realized gain versus frequency with different scan angles in the H-plane in accordance with an illustrative embodiment.

FIG. 19A is a graph showing measured aperture efficiency versus frequency for different scan angles in the E-plane in accordance with an illustrative embodiment.

FIG. 19B is a graph showing measured aperture efficiency versus frequency for different scan angles in the H-plane in accordance with an illustrative embodiment.

### DETAILED DESCRIPTION

The present disclosure provides reconfigurable reflectarray antenna systems and unit cell elements configured to achieve 2-bit phase quantization using an improved switch topology with improved operating bandwidth compared to conventional approaches. A 2-bit reflectarray unit cell is presented that provides an improved operating bandwidth while using only three metallic layers and the minimum number of PIN-diode switches.

In some aspects, a reflectarray antenna element is provided. The reflectarray antenna element comprises a first dielectric layer including a top surface and a bottom surface, wherein the first dielectric layer is formed of a first dielectric material. A conductive ground layer is mounted to the top surface of the first dielectric layer, where the conductive ground layer includes an aperture formed therethrough, and the conductive ground layer is formed of a first conductive material. A second dielectric layer is mounted to the conductive ground layer opposite the first dielectric layer, where the second dielectric layer includes a top surface and a bottom surface. The second dielectric layer is formed of a second dielectric material. A radiating patch layer is mounted to the top surface of the second dielectric layer. The radiating patch layer comprises a plurality of patch elements arranged in a pattern with gaps therebetween, where the radiating patch layer is formed of a second conductive material. A delay line layer is mounted to the bottom surface of the first dielectric layer. The delay line layer comprises a first delay line and a second delay line positioned to couple electromagnetically with the aperture in the conductive ground layer. A first switch and a second switch are mounted to the bottom surface of the first dielectric layer and electrically connected to the first delay line and the second delay line, where each of the first switch and the second switch is configured to be switchable between an ON state and an OFF state. The first delay line is connected to an open-circuit termination and the second delay line is connected to a short-circuit termination.

The conductive ground layer is configured to reflect an electromagnetic wave incident on the radiating patch layer. The aperture in the conductive ground layer is configured to provide electromagnetic coupling between the radiating patch layer and the delay line layer such that the incident electromagnetic wave excites an electromagnetic field that couples through the aperture to the first delay line and the second delay line. A combination of states of the first switch and the second switch provides four distinct operating modes corresponding to four discrete phase shift values applied to a reflected electromagnetic wave relative to the incident electromagnetic wave, wherein the four discrete phase shift values comprise 0 degrees, 90 degrees, 180 degrees, and 270 degrees.

In some embodiments, the aperture in the conductive ground layer has an I-shaped configuration comprising a central rectangular slot extending in a first direction and two rectangular end slots extending in a second direction orthogonal to the first direction from opposite ends of the central rectangular slot. The I-shaped configuration is configured to achieve substantially uniform and linear electromagnetic field distribution along the aperture to enhance coupling with the first delay line and the second delay line.

In some embodiments, the plurality of patch elements comprises four patch elements arranged in a two-by-two array. The gaps between the patch elements are configured to enhance coupling between the radiating patch layer and the delay line layer through the aperture.

In some embodiments, the first switch and the second switch each comprise a PIN diode. Each PIN diode has a forward-bias state corresponding to the ON state and a reverse-bias state corresponding to the OFF state.

In some embodiments, the first delay line and the second delay line are electrically connected to a microstrip line positioned to cross the aperture. The first switch connects the first delay line to the microstrip line when in the ON state, and the second switch connects the second delay line to the microstrip line when in the ON state.

In some embodiments, the first delay line comprises an open-ended stub having an electrical length of approximately 180 degrees at a center operating frequency, and the second delay line comprises a short-circuited stub having an electrical length of approximately 90 degrees at the center operating frequency.

In some embodiments, fan-shaped stubs are provided at an end of each of the first delay line and the second delay line to provide impedance tuning.

In some embodiments, the reflectarray antenna element has an operating bandwidth of at least 6 percent, wherein the operating bandwidth is defined by reflection coefficients of the four distinct operating modes being greater than or equal to −2 dB and phase resolution being greater than or equal to 1.7 bits.

In some embodiments, bias circuitry is provided comprising inductors connected in series with the first switch and the second switch to provide DC bias while blocking radio frequency signals, and capacitors connected in parallel to provide AC coupling while blocking DC bias voltages.

In some embodiments, a reconfigurable reflectarray antenna system is provided. The system comprises a feed antenna configured to generate an incident electromagnetic wave having a first polarization. A reflective array surface comprises a plurality of reflectarray antenna elements arranged in a two-dimensional array, wherein each reflectarray antenna element comprises the structure described above. A control system is operatively connected to the first switch and the second switch of each reflectarray antenna element, wherein the control system is configured to independently control states of the first switch and the second switch of each reflectarray antenna element to provide a selected phase shift distribution across the reflective array surface.

The feed antenna is positioned at a focal distance from the reflective array surface. Each reflectarray antenna element can be configured to reflect the incident electromagnetic wave with one of the four discrete phase shift values based on states of the first switch and the second switch. The selected phase shift distribution is configured to collimate the incident electromagnetic wave into a main beam directed at a selected scan angle relative to a boresight direction of the reconfigurable reflectarray antenna system.

In some embodiments, the plurality of reflectarray antenna elements comprises a 10 -by-10 array of unit cells covering an aperture area. In some embodiments, the feed antenna comprises a horn antenna, with an E-plane oriented along a predetermined axis.

In some embodiments, the reconfigurable reflectarray antenna system is configured to provide beam scanning over a range of at least ±60 degrees in both an H-plane and an E-plane across a frequency range of 5.5 GHz to 6.0 GHz. In some embodiments, the system supports beam scanning up to ±45 degrees with a 3-dB gain reduction across the scanned angles in both the E-plane and H-plane.

In some embodiments, the reconfigurable reflectarray antenna system achieves a maximum realized gain of at least 19 dBi at a broadside scan angle of 0 degrees. In some embodiments, the maximum realized gain is 19.26 dBi at 5.9 GHz in the E-plane.

In some embodiments, a method of operating a reconfigurable reflectarray antenna is provided. The method comprises providing a reflective array surface comprising a plurality of reflectarray antenna elements, where each reflectarray antenna element comprises the structure described above. An incident electromagnetic wave is generated using a feed antenna positioned at a focal distance from the reflective array surface. For each reflectarray antenna element, a required reflection phase shift is determined based on a phase of the incident electromagnetic wave at a center of the reflectarray antenna element and a desired outgoing phase to direct a main beam at a selected scan angle. The required reflection phase shift is quantized into one of four discrete phase shift levels corresponding to four operating modes. States of the first switch and the second switch of each reflectarray antenna element are set based on the quantized phase shift level to establish the corresponding operating mode. The incident electromagnetic wave is reflected from the reflective array surface to form a collimated beam directed at the selected scan angle.

In some embodiments, the four operating modes correspond to combinations of switch states wherein: a first mode (Mode 00) has both switches in an OFF state corresponding to a 0-degree phase shift; a second mode (Mode 01) has the first switch OFF and the second switch ON corresponding to a 270-degree phase shift; a third mode (Mode 10) has the first switch ON and the second switch OFF corresponding to a 90-degree phase shift; and a fourth mode (Mode 11) has both switches in an ON state corresponding to a 180-degree phase shift.

The reflectarray antenna systems and elements disclosed herein provide several advantages over conventional approaches. By utilizing only two PIN diodes per unit cell to achieve 2-bit phase quantization, the disclosed designs minimize fabrication cost and control circuit complexity while maintaining performance. The aperture-coupled configuration with switchable delay lines provides an operating bandwidth exceeding 6 percent, which is significantly broader than conventional two-diode 2-bit designs that typically operate over approximately 1 percent bandwidth. The design combines aperture-coupled antenna principles with delay-line technique to achieve four discrete phase states for 2-bit operation. Full-wave simulation results demonstrate an operating bandwidth of 6.6%, within which the phase resolution exceeds 1.7 bits and the reflection coefficient remains better than −2 dB. Measurements confirm effective beam scanning over a ±60° range in both the E-and H-planes across the 5.6-6 GHz frequency band. The enhanced bandwidth enables effective beam scanning over wide angular ranges across frequency ranges exceeding 400 MHz. The I-shaped aperture configuration achieves improved electromagnetic coupling efficiency with nearly uniform and linear field distribution, enhancing overall antenna performance. The design is compatible with standard printed circuit board fabrication technology, facilitating cost-effective manufacturing at scale.

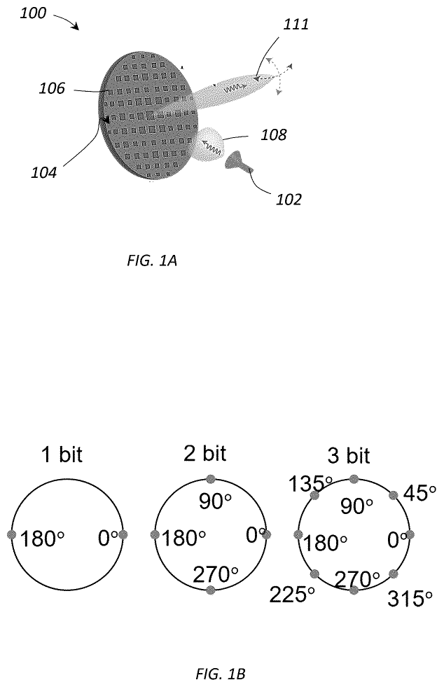

Referring to FIG. 1A, a reconfigurable reflectarray antenna system 100 is configured to provide electronically steerable beam scanning functionality. The system 100 includes a feed antenna 102 and a reflective array surface 104 comprising a plurality of phase-shifting unit cell elements 106 arranged in a two-dimensional array. Feed antenna 102 is positioned at a focal distance from reflective array surface 104 and is configured to generate an incident electromagnetic wave 108 that illuminates reflective array surface 104. Each unit cell element 106 of reflective array surface 104 is configured to reflect incident electromagnetic wave 108 with a controllable phase shift to produce a reflected electromagnetic wave that collectively forms a collimated beam 110 directed at a selected scan angle relative to a boresight direction.

In operation, feed antenna 102 generates incident electromagnetic wave 108 having a wavefront that propagates toward reflective array surface 104. Each unit cell element 106 applies a specific phase shift to the portion of incident electromagnetic wave 108 impinging thereon. By independently controlling the phase shift applied by each unit cell element 106 according to a calculated phase distribution pattern, the system collectively transforms the feed wavefront into a substantially planar wavefront that propagates as a collimated beam in the selected direction. The direction of the collimated beam can be dynamically changed by reconfiguring the phase shift distribution across reflective array surface 104, thereby providing beam scanning capability without mechanical movement of any antenna components.

Feed antenna 102 may be a low-gain antenna such as a dipole antenna, a monopole antenna, a helical antenna, a microstrip antenna, a patch antenna, a feed horn antenna, a slot antenna, or other suitable radiating element configured to generate incident electromagnetic wave 108. As described in more detail herein, feed antenna 102 can be oriented such that polarization of incident electromagnetic wave 108 is aligned with a predetermined polarization direction of unit cell elements 106. The E-plane of feed antenna 102 can be aligned with the x-axis.

Reflective array surface 104 may be planar or may conform to a curved surface depending on application requirements. In the illustrative embodiment, reflective array surface 104 is substantially planar and is arranged perpendicular to the boresight direction. Reflective array surface 104 has an aperture length and width that define the overall aperture area. In some embodiments, reflective array surface 104 can comprises a 10 -by-10 array of unit cell elements 106, with each unit cell element 106 having lateral dimensions of between about 10 mm to about 100 mm, or between about 20 mm to about 50 mm. In alternative embodiments, reflective array surface 104 may comprise larger or smaller arrays such as 20-by-20, 30-by-30, 40-by-40, 50-by-50, or other suitable array sizes and shapes (e.g., 10-by-30 array, etc.) to achieve desired gain and directivity characteristics.

System 100 further can also comprise a control system operatively connected to each unit cell element 106. The control system can be configured to independently control the operating mode of each unit cell element 106 to establish the desired phase shift distribution across reflective array surface 104. In some embodiments, the control system comprises a microcontroller in signal communication with the system to independently control bias states of the diodes in the array. In some embodiments as described in more detail herein, control system comprises a field-programmable gate array (FPGA) board with associated shift registers, D-type flip-flops, and a row-select decoder. The control system can receive an input specifying a desired scan angle and calculate the required phase shift for each unit cell element 106 based on the focal distance, unit cell positions, and operating frequency. The control system can then set the switch states of each unit cell element 106 to achieve the calculated phase shifts.

Referring to FIG. 1B, phase quantization schemes for reflectarray antennas are illustrated. A 1-bit phase quantization scheme provides two discrete phase states (0° and 180°). A 2-bit phase quantization scheme provides four discrete phase states (0°, 90°, 180°, and 270°) represented at 90-degree intervals. A 3-bit phase quantization scheme provides eight discrete phase states (0°, 45°, 90°, 135°, 180°, 225°, 270°, and 315°). The 2-bit scheme represents a balance between performance improvement and system complexity, recovering approximately 3 dB of directivity lost in 1-bit schemes while requiring only two switches per unit cell compared to four or more switches required for 3-bit or higher quantization schemes.

Referring to FIGS. 2A and 2B, the detailed structure of unit cell element 106 is shown. The design approach is based on an aperture-coupled antenna configuration, in which switchable delay lines located on the bottom layer are electromagnetically coupled to a radiating element on the top layer through an aperture in the ground plane. The architecture of the proposed unit cell consists of three metallic layers separated by dielectric substrates. Unit cell element 106 comprises a multi-layer structure including a first dielectric layer 202, a conductive ground layer 204, a second dielectric layer 206, a radiating patch layer 208, and a delay line layer 210. The layers are stacked vertically along a z-axis direction and extend laterally in x and y directions.

The first dielectric layer 202 forms a substrate layer and includes a top surface in contact with the conductive ground layer 204 and a bottom surface in contact with the delay line layer 210. The first dielectric layer 202 can be formed from a first dielectric material selected to provide appropriate permittivity and loss characteristics at the operating frequency. The first dielectric layer 202 can have a thickness h1 in the z-direction, which can be in a range of about 0.5 mm to about 3 mm, or between about 1 mm to about 2 mm. The first dielectric layer 202 has lateral dimensions corresponding to the unit cell size to provide a substantially square unit cell shape.

The conductive ground layer 204 can be mounted to the top surface of the first dielectric layer 202. The conductive ground layer 204 can be formed of a conductive material such as copper, aluminum, gold, silver, or other electrically conductive metal or alloy. The conductive ground layer 204 functions as a reflecting surface to reflect incident electromagnetic waves back towards the radiating patch layer 208.

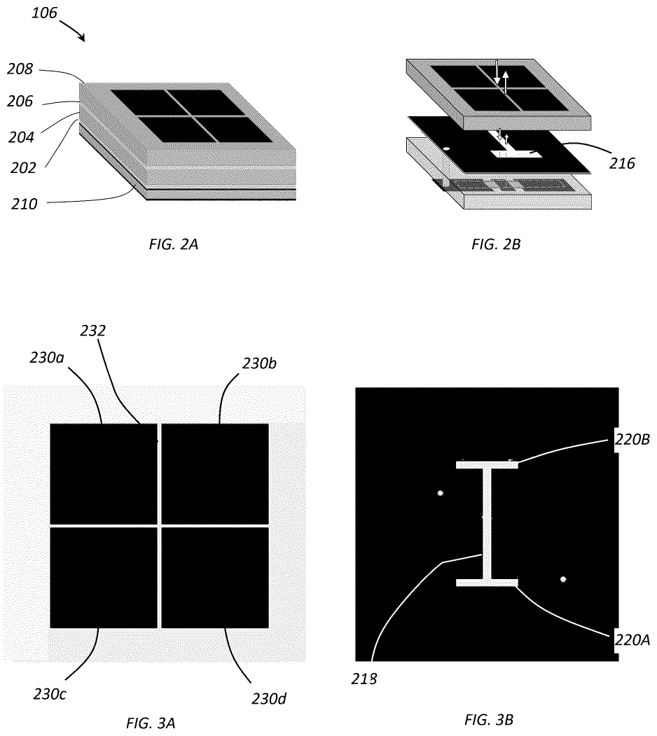

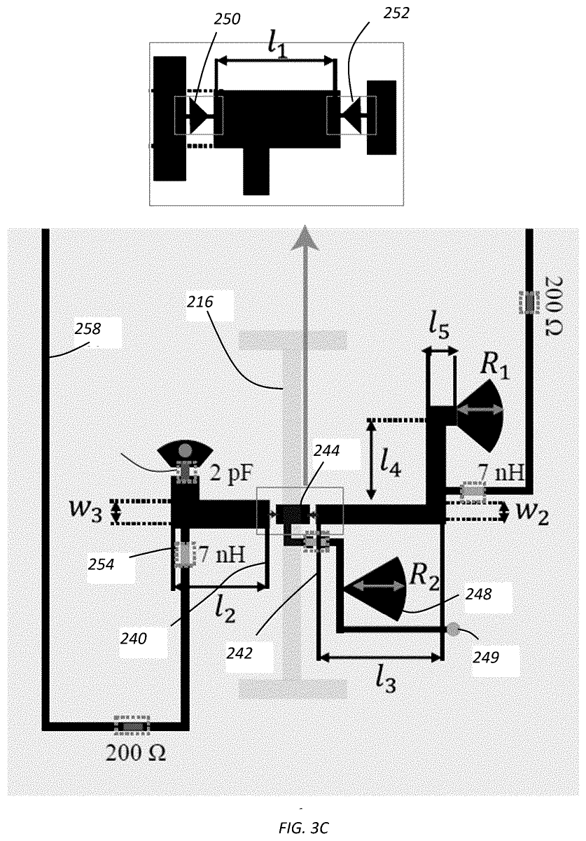

An aperture 216 can be formed through conductive ground layer 204. The aperture 216 can provide electromagnetic coupling between radiating patch layer 208 on the top side and delay line layer 210 on the bottom side of conductive ground layer 204. The aperture 216 can have a specially configured shape to improve or optimize coupling efficiency. Referring to FIG. 3B, aperture 216 has an I-shaped configuration comprising a central rectangular slot 218 extending in the x-direction and two rectangular end slots 220a, 220b extending in the y-direction from opposite ends of central rectangular slot 218. The I-shaped slot is etched in the common ground plane, and is configured to generate a nearly uniform field distribution across the aperture, thereby reinforcing the coupling mechanism.

In some embodiments, the shape of aperture 216 may differ from the I-shaped configuration. In one alternative embodiment, aperture 216 comprises an H-shaped configuration. In another alternative embodiment, aperture 216 comprises a cross-shaped configuration with four arms extending radially from a central point. In yet another alternative embodiment, aperture 216 comprises a single elongated slot. The selection of aperture shape affects coupling strength and frequency response characteristics.

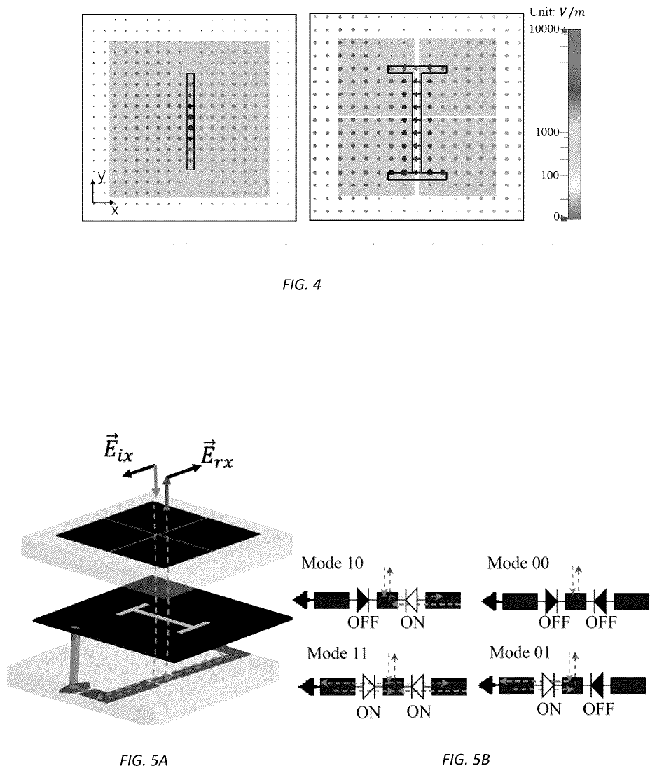

Referring to FIG. 4, the difference in average E-field distribution across the aperture slot is illustrated between a single-slot configuration with a regular, solid square patch and an I-shaped slot configuration with the disclosed compound patch. The E-field distribution along the I-shaped slot can be linear and has a stronger magnitude. In some embodiments, central rectangular slot 218 has specific dimensions, while end slots 220a, 220b each have specific dimensions. The specific dimensions are selected based on the operating wavelength and desired coupling strength.

Returning to FIGS. 2A-2B, the second dielectric layer 206 can be mounted to the conductive ground layer 204 on an opposite side from the first dielectric layer 202. The second dielectric layer 206 comprises a top surface coupled to the radiating patch layer and a bottom surface coupled to the top surface of the conductive ground layer. The second dielectric layer 206 can be formed from a second dielectric material, which can be the same or different than the dielectric material used to form the first dielectric layer 202. In some embodiments, the second dielectric layer 206 can comprise one or more layers of material, and the thickness of the second dielectric layer 206 can be the same as the first dielectric layer 202 or thicker than the first dielectric layer 202. In some embodiments, a ratio of the thickness of the second dielectric layer to the thickness of the first dielectric layer can be between about 0.95 to about 1.5.

The radiating patch layer 208 can be mounted to a top surface of second dielectric layer 206. The radiating patch layer 208 can be formed from an electrically conductive material, typically a metal such as copper, aluminum, gold, silver or other conductive metals or alloys. Referring to FIG. 3A, the radiating patch layer 208 can comprise a plurality of patch elements arranged in a pattern. In some aspects, the radiating patch in the top layer of the unit cell can be divided into four patches with a gap between them to enhance the coupling level with delay lines in the bottom layer. As shown, radiating patch layer 208 can comprise four patch elements 230a, 230b, 230c, 230d arranged in a two-by-two array. Patch elements 230a, 230b, 230c, 230d are separated by gaps 232 to enhance electromagnetic coupling with delay line layer 210 through aperture 216. In some embodiments, the top-layer radiator is a compound patch partitioned into four substantially equal square sub-patches separated by narrow gaps, which further enhances coupling with the underlying delay lines. In these embodiments, each patch element can have a substantially square shape. The divided patch configuration with the gaps 232 can increase the effective coupling area and strengthen the electromagnetic interaction between the radiating patch layer 208 and the delay line layer 210 compared to a single continuous patch.

The delay line layer 210 can be mounted to a surface of first dielectric layer 202 on an opposite side from conductive ground layer 204. Referring to FIG. 3C, the delay line layer 210 comprises conductive traces forming a first delay line 240, a second delay line 242, and a connecting microstrip line 244. The bottom layer includes two delay lines, one connected to an open-ended stub while another connected to a short-circuited stub. The first delay line 240 and the second delay line 242 are positioned beneath aperture 216 to achieve electromagnetic coupling therewith. The delay lines are connected to a short microstrip line running across the middle of the slot aperture through two PIN diodes. On the bottom layer, the delay lines are connected to a short microstrip line positioned across the middle of the slot aperture through two PIN diodes. The first delay line 240 extends from connecting microstrip line 244 and terminates in an open-circuit termination. The second delay line 242 extends from connecting microstrip line 244 in an opposite direction and terminates in a short-circuit termination 248 that connects to conductive ground layer 204 through a via 249. Connecting microstrip line 244 extends transversely across the region beneath aperture 216.

In some embodiments, different types of switches may be used instead of PIN diodes. In one alternative embodiment, MEMS (microelectromechanical systems) switches are used, providing lower insertion loss but slower switching speed. In another alternative embodiment, varactor diodes are used to provide continuous phase tuning rather than discrete switching. In yet another alternative embodiment, electronic phase shifters such as loaded-line phase shifters or switched-line phase shifters are integrated into delay line layer 210.

In some embodiments, the terminations of the delay lines may be varied. In one alternative embodiment, both first delay line 240 and second delay line 242 terminate in open circuits with different lengths to provide different phase shifts. In another alternative embodiment, both delay lines terminate in short circuits with different lengths. In yet another alternative embodiment, one or both delay lines terminate in reactive loads (capacitive or inductive) to provide additional phase shift control.

The electrical lengths of the open-ended and short-circuited stubs were designed to be 180° and 90°, respectively. The lengths of first delay line 240 and second delay line 242 are selected to provide desired phase shift characteristics when activated. Fan-shaped stubs are introduced at the end of each microstrip line to provide additional degrees of freedom for impedance tuning.

Unit cell element 106 further includes a first switch 250 and a second switch 252 mounted to a bottom surface 214 of first dielectric layer 202 and electrically connected to delay line layer 210. The delay lines are connected to a short microstrip line running across the middle of the slot aperture through two PIN diodes. In some embodiments, first switch 250 and second switch 252 each comprise a PIN diode. The PIN diodes can function as electronically controlled switches that can be switched between a conducting (ON) state when forward-biased and a non-conducting (OFF) state when reverse-biased. Each PIN diode operates as an SPST switch, with its ON and OFF states controlled by forward and reverse biasing, respectively. Each PIN diode functions as an SPST switch with the ON (referred to as bit 1) and OFF (referred to as bit 0) states controlled by the corresponding forward-and reverse-bias states.

The first switch 250 is electrically connected between connecting microstrip line 244 and first delay line 240. When the first switch 250 is in the ON state, the first delay line 240 is electrically connected to connecting microstrip line 244, allowing electromagnetic energy to propagate along the first delay line 240 to the open-circuit termination. When the first switch 250 is in the OFF state, the first delay line 240 is electrically isolated from the connecting microstrip line 244, preventing energy propagation along the first delay line 240.

The second switch 252 is electrically connected between connecting microstrip line 244 and the second delay line 242. When the second switch 252 is in the ON state, the second delay line 242 is electrically connected to the connecting microstrip line 244, allowing electromagnetic energy to propagate along the second delay line 242 to the short-circuit termination 248. When the second switch 252 is in the OFF state, the second delay line 242 is electrically isolated from the connecting microstrip line 244, preventing energy propagation along the second delay line 242.

Bias circuitry is provided to control the states of the first switch 250 and the second switch 252. In some embodiments, the inductors 254 are connected in series with the anode and the cathode of each PIN diode to provide DC bias while blocking radio frequency signals. RF isolation for the bias lines of the delay lines can be realized using the inductors. The capacitors 256 (e.g., picofarad capacitors) are connected in parallel to provide AC coupling while blocking DC bias voltages. To independently control the two PIN diodes, the central short microstrip line can be grounded, while the short-circuit stub can be connected to ground through a capacitor, providing DC isolation. To limit the forward current of each PIN diode, a series resistor is inserted in its bias line. The bias lines 258 connect to the control system to supply forward-bias or reverse-bias voltages to control the states of the first switch 250 and the second switch 252 independently.

The disclosed design approach is based on an aperture-coupled antenna configuration, in which switchable delay lines located on the bottom layer are electromagnetically coupled to a radiating element on the top layer through the aperture in the ground plane. The operating principle of unit cell element 106 is based on aperture coupling combined with switchable delay lines. An incident electromagnetic (EM) wave from the feed antenna impinging on the radiating patch will excite an EM field between the patch and the ground plane, which couples with the microstrip lines (e.g., delay lines) in the bottom layer via the aperture. When the radiating element is excited by a normally incident plane wave with a given linear polarization, the wave couples through the aperture into the underlying microstrip delay lines, propagates toward an open-circuited stub, a short-circuited stub, or both, and is subsequently reflected back through the aperture. As a result, the reflected wave is re-radiated through the radiating element with a phase shift primarily determined by electrical length of the signal path on the delay lines. This induces an EM wave that propagates on the delay lines and is reflected at the open-circuited or short-circuited end of the lines. The returning wave travels back on the delay lines, which in turn is coupled to and reradiated by the patch into free space as a reflected wave. The termination (open-or short-circuit) and length of the delay lines can be used to control the relative phase shift of the reflected wave with respect to that of the incident wave.

In conventional aperture-coupled, delay-line unit cells, an auxiliary ground plane is typically inserted behind the structure to suppress energy leakage and improve the reflection coefficient magnitude. In the disclosed design herein in some embodiments, that extra ground plane is removed or not present, resulting in a more compact structure with lower complexity. A high reflection-coefficient magnitude is instead achieved by controlling both the aperture slot and the geometry of the radiating patch.

Referring to FIGS. 5A and 5B, the operational principle of the proposed unit cell in its four discrete switching states is illustrated. The bottom layer comprises two microstrip delay lines, one connected to an open-ended stub and the other terminated with a short-circuited stub. When illuminated by an incoming plane wave with its electric field vector oriented orthogonally to the I-shaped aperture, the induced currents predominantly flow along the branch of the microstrip line where the corresponding PIN diode is switched to the ON state.

In Mode 00, with both PIN diodes in the OFF state, the incoming signal is expected to undergo immediate reflection upon encountering the short transmission line connected between the two diodes. Typically, the reflection phase varies linearly with the length of the delay line. However, line resonances may introduce nonlinearities. These deviations can be mitigated by appropriately tuning the input impedance seen by the delay lines. In some aspects, two fan-shaped stubs can be introduced at the end of each microstrip line to provide additional degrees of freedom for impedance tuning.

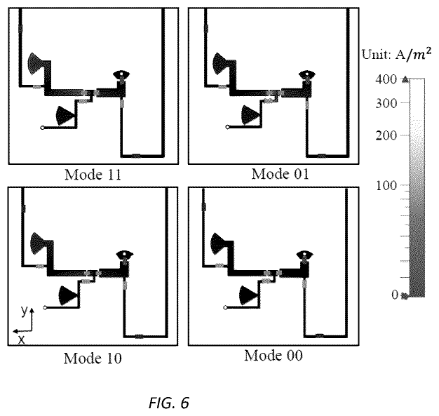

Referring to FIG. 6, the average current distributions along the two delay lines for each of the four operational states are illustrated. Although the currents predominantly flow along the microstrip line branches as intended by design, some current leakage occurs along the branches in the OFF state due to the imperfect isolation provided by the PIN diodes. It is observed that the current magnitudes on the bias lines are significantly smaller compared to those on the main signal paths. Due to the higher current magnitude present on the central short microstrip line, a combination of a fan-shaped stub and inductor can be employed for enhanced RF isolation.

When an induced wave propagates along first delay line 240 to open-circuit termination, the wave is reflected. When an induced wave propagates along second delay line 242 to short-circuit termination 248, the wave is reflected. The reflected waves travel back along the delay lines to connecting microstrip line 244, couple back through aperture 216, and are reradiated by radiating patch layer 208 into free space as a reflected electromagnetic wave.

The effective electrical length of the path from connecting microstrip line 244 to the termination and back determines the phase shift of the reflected electromagnetic wave relative to the incident electromagnetic wave. By independently controlling the states of first switch 250 and second switch 252, four distinct combinations of activated delay lines are achieved, providing four different effective electrical path lengths and four discrete phase shift values. Independent switching of these diodes provides four discrete operating states, resulting in relative reflection-phase shifts of 0°, 90°, 180°, and 270°.

Unit cell element 106 is configured to operate in four distinct modes corresponding to four combinations of switch states, providing 2-bit phase quantization. By switching the two diodes on and off independently, the unit cell can provide four different operating modes with relative reflection phase shift values of 0°, 90°, 180°, and 270°. The four modes of the unit cell are also referred to as Bit 00, 01, 10, and 11 where each digit refers to the state of one diode.

Mode 00 (Bit 00): Both first switch 250 and second switch 252 are in the OFF state. Neither first delay line 240 nor second delay line 242 is electrically connected to connecting microstrip line 244. Mode 00 provides a reference phase shift of approximately 0 degrees.

Mode 01 (Bit 01): First switch 250 is in the OFF state, and second switch 252 is in the ON state. First delay line 240 is isolated, while second delay line 242 is electrically connected to connecting microstrip line 244. Electromagnetic energy propagates along second delay line 242 to short-circuit termination 248 and is reflected back. The configuration provides a phase shift of approximately 270 degrees relative to Mode 00.

Mode 10 (Bit 10): First switch 250 is in the ON state, and second switch 252 is in the OFF state. First delay line 240 is electrically connected to connecting microstrip line 244, while second delay line 242 is isolated. Electromagnetic energy propagates along first delay line 240 to open-circuit termination 246 and is reflected back. The electrical length of first delay line 240 is selected such that Mode 10 provides a phase shift of approximately 90 degrees relative to Mode 00.

Mode 11 (Bit 11): Both first switch 250 and second switch 252 are in the ON state. Both first delay line 240 and second delay line 242 are electrically connected to connecting microstrip line 244. Electromagnetic energy propagates along both delay lines. The combined electromagnetic interaction of the open-circuit and short-circuit terminations produces a phase shift of approximately 180 degrees relative to Mode 00.

The electrical lengths of first delay line 240 and second delay line 242 are designed such that the phase differences between modes are approximately 90 degrees, providing evenly distributed phase quantization levels for 2-bit operation.

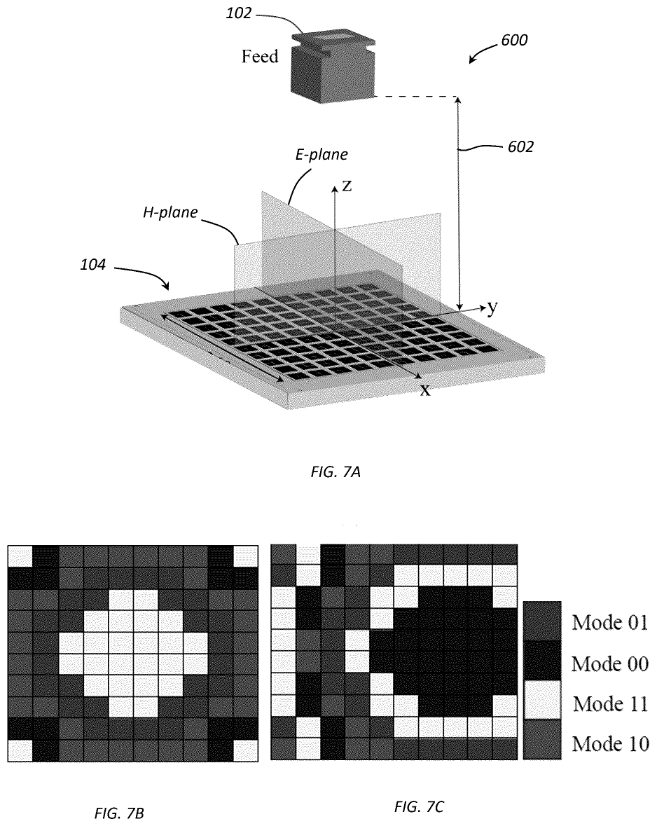

Referring to FIG. 7A, a complete reconfigurable reflectarray antenna system 600 is shown. The proposed 2-bit phase shifters were used to construct a reconfigurable reflectarray prototype consisting of a plurality of individual elements arranged in a pattern. While FIG. 7A illustrates a pattern comprising 10×10 elements, any suitable pattern or number of individual elements can be used. In some aspects, the resulting pattern may not be a square array and the individual elements can be used to form a suitable patter on a flat or 3-D varying surface. In some embodiments, the reflective array surface conforms to a curved surface rather than being planar. In one alternative embodiment, reflective array surface 104 is formed on a cylindrical surface to provide a wider azimuthal scan range. In another alternative embodiment, reflective array surface 104 is formed on a spherical surface to provide hemispherical coverage. System 600 comprises feed antenna 102 positioned at focal distance 602 from reflective array surface 104. In use, the reflectarray can be illuminated by the feed antenna.

Feed antenna 102 can be positioned at the center of reflective array surface 104 along the z-axis at the focal distance 602. The E-plane of the horn antenna can be aligned with the x-axis. Feed antenna 102 has an E-plane oriented along the y-axis to provide incident electromagnetic wave with vertical polarization. In alternative embodiments, feed antenna 102 may be positioned at off-center locations or at different focal distances to achieve different illumination patterns or scan angle ranges. In some embodiments, an off-center feed configuration can be used to reduce aperture blockage effects.

The operating frequency range of system 600 can be in a range from 5.5 GHz to 6.0 GHz. System 600 is configured to provide beam scanning over a wide angular range. In some embodiments, system 600 provides effective beam scanning over a range of ±60° in both the H-plane (x-z plane) and E-plane (y-z plane). In some embodiments, the system supports beam scanning up to ±45° with a 3-dB gain reduction across the scanned angles in both the E-and H-Planes.

In some embodiments, the dimensions of various components may be scaled to operate at different frequency ranges. For operation at higher frequencies, all dimensions may be proportionally reduced. For operation at lower frequencies, all dimensions may be proportionally increased. The scaling factor is approximately inversely proportional to the ratio of operating frequencies.

The phase shift distribution across reflective array surface 104 can be calculated to achieve a desired beam direction. The operating mode of each phase-shifting element is determined based on the required reflection phase shift to provide the desired main beam direction. The operating mode of each phase-shifting element can be selected based on the required reflection phase to steer the main beam in the desired direction. The phase of the incident electric field at the center of each unit cell, denoted as φ_{inc}(xᵢ, yᵢ), along with the target reflection phase φₒᵤₜ(xᵢ, yᵢ), is used to determine the necessary phase shift that each unit cell must provide. The phase of the incident electric field at the center of each unit cell, represented as φ_{inc}(xᵢ, yᵢ), along with the desired outgoing phase φₒᵤₜ(xᵢ, yᵢ), is used to determine the reflection phase shift that each unit cell must provide:

$${φ}_{ref} ( {x}_{i} , {y}_{i} ) = {φ}_{out} ( {x}_{i} , {y}_{i} ) - {φ}_{inc} ( {x}_{i} , {y}_{i} ) \qquad ( Eq . 1 )$$

The desired outgoing phase φₒᵤₜ(xᵢ, yᵢ) is calculated based on the desired beam direction (θ₀, φ₀) and the spherical coordinates (rᵢ, φᵢ) of the unit cell's center, using the following expression:

$${φ}_{out} ( {x}_{i} , {y}_{i} ) = - ( 2 π / λ ) \times {r}_{i} \times sin ( {θ}_{0} ) \times cos ( {φ}_{i} - {φ}_{0} ) \qquad ( Eq . 2 )$$

where λ is the operating wavelength, rᵢ is the radial distance from the array center to the unit cell center in the x-y plane, and φᵢ is the azimuthal angle.

The phase of incident electromagnetic wave 108 at the center of each unit cell, φ_{inc}(xᵢ, yᵢ), is determined by the spherical wave propagation from feed antenna 102.

The reflection phase shifts required for the unit cells are mapped to the range of −180° to 180°, and quantized into four levels. The required reflection phase shifts for the unit cells, adjusted to fit within the range of −180° to 180°, are quantized into four levels, which subsequently define the operating modes of the unit cells according to the following expression:

$$Mode = 00 , if - 45 ° \leq {φ}_{ref} ( {x}_{i} , {y}_{i} ) < 45 ° \qquad ( Eq . 3 )$$

$$Mode = 11 , if 135 ° \leq {φ}_{ref} ( {x}_{i} , {y}_{i} ) or {φ}_{ref} ( {x}_{i} , {y}_{i} ) < - 135 °$$

$$Mode = 10 , if 45 ° <= {φ}_{ref} ( {x}_{i} , {y}_{i} ) < 135 °$$

$$Mode = 01 , if - 135 ° <= {φ}_{ref} ( {x}_{i} , {y}_{i} ) < - 45 °$$

These levels correspond to the operational states assigned to each unit cell. Following this procedure, two examples of the pattern of discrete spatial phase shifters used for this 2-bit phase quantization were calculated. Referring to FIGS. 7B and 7C example phase distribution patterns are shown for different beam directions. FIG. 7B shows the distribution pattern for a broadside beam direction (θ₀=0°, φ₀=0°), resulting in a substantially symmetric concentric pattern. FIG. 7C shows the distribution pattern for a tilted beam direction (θ₀=15°, φ₀=0°), resulting in an asymmetric pattern with a steeper phase gradient in the direction of beam tilt. The resulting patterns—corresponding to beam steering toward (θ₀=0°, φ₀=0°) and (θ₀=30°, φ₀=0°)—are illustrated.

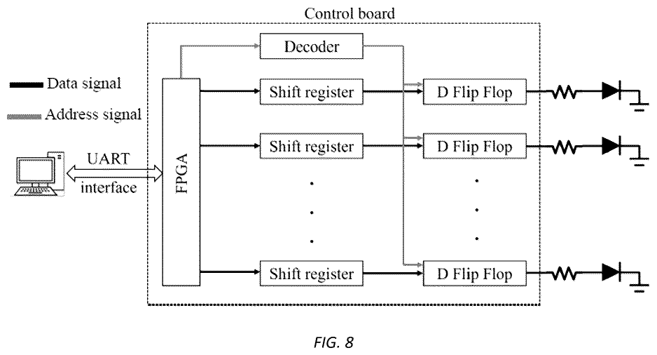

Referring to FIG. 8, the control architecture used to reconfigure the plurality of PIN diodes embedded in the reconfigurable reflectarray (RRA) is shown. In one embodiment, a control board with a corresponding number of input/output (I/O) pins was used to independently control bias states of all of the diodes in the array.

In some embodiments, a control network can comprise D-type flip-flops (DFFs), shift registers, and a single row-select decoder. The resulting outputs are latched by the DFFs and routed to the corresponding diodes. The FPGA updates the array on a row-by-row basis, each row containing ten diodes. Serial data representing the desired bias states can be clocked into the shift registers and then propagated through the DFFs. The decoder gates the row clock, ensuring that only the selected row accepts new data. Each diode is forward-biased, resulting in a total power dissipation when all diodes are in the ON state.

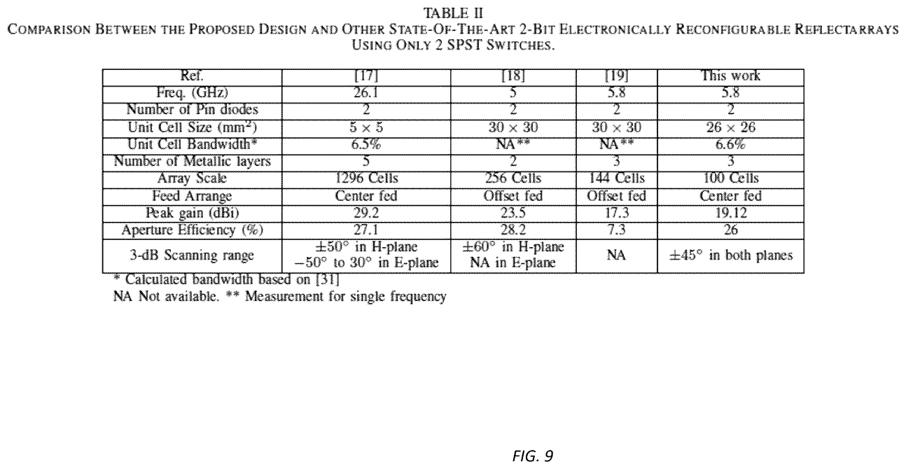

Referring to FIG. 9, a comparison table shows performance metrics of the disclosed reflectarray design compared to earlier art designs using two PIN diodes for 2-bit operation. For 2-bit reflectarray antennas, only a limited number of studies have demonstrated 2-bit performance using just two SPST switches per unit cell. However, all prior references are estimated to have element bandwidths of approximately 1 percent, and many do not report operating bandwidths or characterize beam steering performance across a frequency range.

The disclosed design achieves an element bandwidth of 6.6 percent, which is more than five times broader than earlier systems while maintaining the minimum switch count of two PIN diodes and using only three metallic layers. The disclosed design exhibits a narrower 3-dB scanning range of ±45° in the H-plane compared to some designs, but provides a wider scanning range of ±45° in the E-plane. The maximum gain of 19.12 dBi and aperture efficiency of 26 percent are comparable to several references, considering differences in array sizes.

The improved bandwidth performance of the disclosed design is attributed to the aperture-coupled delay line configuration with optimized I-shaped aperture geometry and divided radiating patch structure. The I-shaped aperture provides stronger and more uniform coupling with linear field distribution compared to conventional rectangular or circular apertures, reducing frequency sensitivity. The divided patch configuration enhances coupling while maintaining compact unit cell size. The careful selection of delay line lengths, termination types, and fan-shaped stubs for impedance tuning provides properly spaced phase states across the operating bandwidth.

The disclosed reconfigurable reflectarray antenna systems and unit cell elements provide numerous advantages over conventional approaches. By utilizing only two PIN diodes per unit cell to achieve 2-bit phase quantization, the disclosed designs minimize fabrication cost and complexity while maintaining high performance. The minimum switch count directly reduces the cost per unit cell, as PIN diodes typically represent a significant fraction of overall fabrication cost in reconfigurable reflectarrays.

The aperture-coupled delay line configuration provides an operating bandwidth exceeding 6 percent, significantly broader than conventional two-switch 2-bit designs that typically operate over approximately 1 percent bandwidth. Full-wave simulations validate that the unit cell maintains a reflection magnitude above −2 dB and achieves a phase resolution greater than 1.7 bits over a 6.6% bandwidth. The enhanced bandwidth enables effective beam scanning across wide angular ranges over frequency ranges exceeding 400 MHz, making the disclosed designs suitable for wideband communication systems, frequency-agile radar systems, and multi-function systems operating across multiple frequency channels.

The I-shaped aperture configuration achieves improved electromagnetic coupling efficiency with nearly uniform and linear field distribution along the aperture compared to conventional aperture shapes such as rectangular, circular, or cross-shaped apertures. The uniform coupling enhances phase shift consistency across the operating bandwidth and reduces frequency sensitivity.

The divided patch configuration with gaps enhances coupling between the radiating patch layer and the delay line layer through the aperture. The gaps increase the effective perimeter of the patch elements participating in electromagnetic coupling, strengthening the interaction. The four-patch arrangement provides a balanced configuration that maintains polarization alignment and minimizes cross-polarization levels.

The disclosed designs are compatible with standard printed circuit board fabrication technology, facilitating cost-effective manufacturing at scale. The multi-layer PCB structure can be fabricated using conventional photolithographic, etching, plating, and lamination processes. The integration of PIN diodes and bias components uses standard surface-mount assembly techniques. This manufacturability enables production of large-scale reflectarray systems with hundreds or thousands of unit cells at reasonable cost.

The disclosed systems exhibit excellent beam scanning performance with effective steering over wide angular ranges. Measurement results demonstrate stable beam scanning over a ±60° angular range in both E-and H-planes, with a gain variation of less than 3.0 dB across the 5.6-6 GHz frequency band. The maximum realized gain and aperture efficiency provide sufficient directivity for many communication and radar applications.

The disclosed systems handle higher power levels compared to conventional active phased array systems because heat-generating components (switches and bias circuitry) are distributed across the aperture rather than concentrated in transmit/receive modules. The passive reflection principle means that no active amplification occurs at the reflective surface, reducing thermal management requirements.

Applications of the disclosed reconfigurable reflectarray antenna systems include satellite communications, terrestrial wireless communications, radar systems, sensing systems, and test and measurement systems. In satellite communications, the disclosed systems can be used for ground station antennas providing beam tracking of moving satellites or beam steering to serve multiple satellites without mechanical gimbal systems. In terrestrial wireless communications, the disclosed systems can provide base station antennas with electronic beam steering for 5G and future 6G systems operating in C-band frequencies around 5-6 GHz.

In radar systems, the disclosed reconfigurable reflectarrays can provide electronically scanned antennas for airborne radar, automotive radar, or maritime radar applications. The ability to rapidly reconfigure beam direction enables search, tracking, and imaging functions without mechanical rotation. In sensing and imaging systems, the disclosed designs can provide steerable beams for remote sensing, weather monitoring, or security surveillance applications.

### EXAMPLES

The disclosure having been generally described, the following examples are given as particular embodiments of the disclosure and to demonstrate the practice and advantages thereof. It is understood that the examples are given by way of illustration and are not intended to limit the specification or the claims in any manner.

### Example 1

### Performance Characteristics and Simulation Results

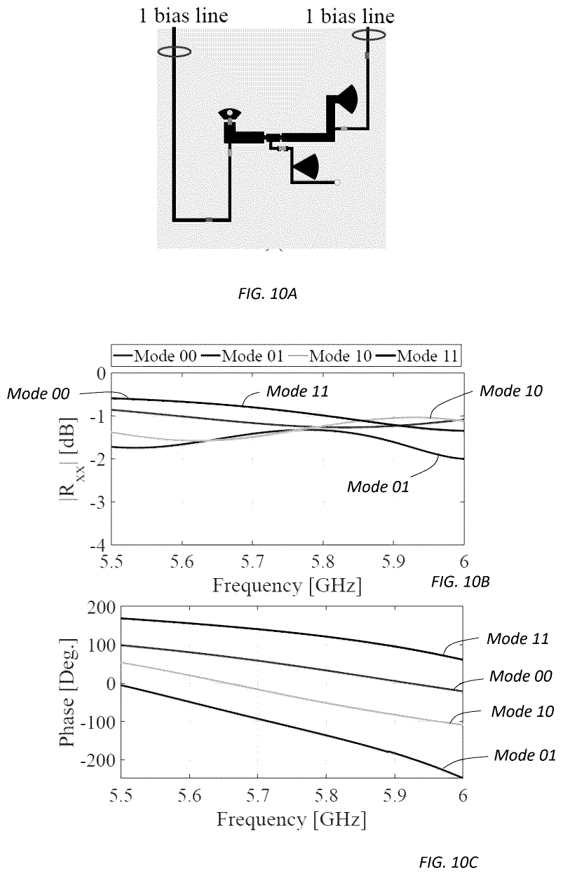

The unit cell models for the four reflection modes were simulated using the unit-cell boundary condition in CST Microwave Studio. Referring to FIG. 10A, a scenario is illustrated where the unit cell is positioned at the center of the reflectarray, without any bias lines from neighboring cells passing through it. Referring to FIG. 10B, the simulated magnitudes and phases of the reflection coefficients Rₓₓ for the four operational modes of the proposed unit cell are presented.

The bandwidth of the proposed 2-bit unit cell was evaluated using two criteria: (1) the phase differences between adjacent states must remain within 90°±25 °, and (2) the dominant reflection coefficients for all four modes must be no less than −2.0 dB. The phase shifter in the four reflection modes was simulated using the unit cell boundary condition in CST Microwave Studio. The bandwidth of the unit cell was defined using a relaxed condition such that the dominant reflection coefficients of the four modes are no smaller than −2.0 dB and the phase resolution is no less than 1.7 bits. With this bandwidth definition, the unit cell was found to operate from 5.6 to 5.9 GHz based on simulation results. Based on these conditions, the 2-bit bandwidth of the unit cell for this simulation scenario was determined to be 6.1% (5.6-5.95 GHz).

Across a frequency range from 5.6 GHz to 5.9 GHz, the magnitude of the reflection coefficient for all four modes remains above −2 dB, indicating strong reflection with minimal absorption losses. The relatively flat response across this bandwidth demonstrates that unit cell element 106 maintains consistent amplitude performance across the four operating modes over the 300 MHz bandwidth.

At the center frequency of approximately 5.75 GHz, the phase values are approximately 0 degrees for Mode 00, 90 degrees for Mode 10, 180 degrees for Mode 11, and 270 degrees for Mode 01, demonstrating accurate 2-bit phase quantization. The phase separation between adjacent modes remains relatively constant across the operating bandwidth, ensuring consistent 2-bit operation.

This bandwidth performance represents a significant improvement over conventional 2-bit reflectarray unit cells using only two PIN diodes. Prior designs typically provide 2- bit operation over bandwidths of approximately 1 percent and characterize beam-scanning performance at only single frequency points. The disclosed design achieves a bandwidth that is more than five times broader while maintaining the minimum switch count of two PIN diodes per unit cell.

### Example 2

### Impact of Bias Line and Oblique Angle on Unit Cell's Bandwidth

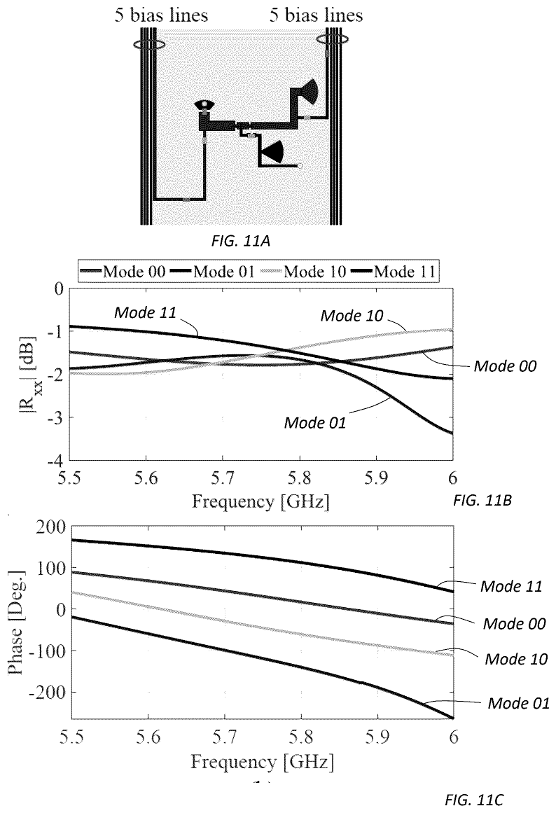

For the implementation of a 10×10 array, the unit cell structure deviates from a perfectly periodic configuration due to variations in the number of bias lines crossing each unit cell. To assess the impact of this non-uniformity, the reflection responses of the unit cell under the influence of bias lines extending from adjacent elements were investigated. Referring to FIG. 11A, a worst-case scenario is illustrated in which ten straight bias lines traverse a single unit cell. Referring to FIGS. 11B and 11C, the simulated reflection magnitude and phase responses for this scenario are presented.

Compared with the baseline case of two bias lines, the phase response for the case of ten bias lines remains consistent, preserving the 2-bit phase quantization criterion across the 5.6-5.95 GHz band. However, a noticeable degradation is observed in the magnitude response, particularly for Mode 01, where the reflection coefficient drops below −2 dB around 5.9 GHz, reducing the effective magnitude bandwidth. This degradation is primarily attributed to increased coupling between the radiating patches and the denser bias line distribution. Despite this, the phase responses for all four operational modes remain stable, confirming that the proposed unit cell maintains reliable 2-bit phase states even with a dense biasing network on the bottom layer.

### Example 3

### Oblique Incidence Angle

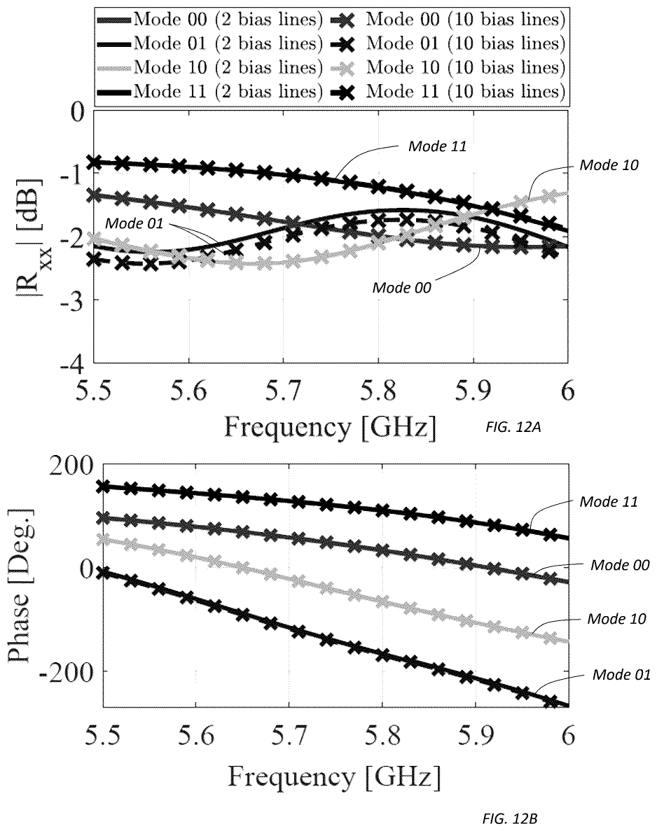

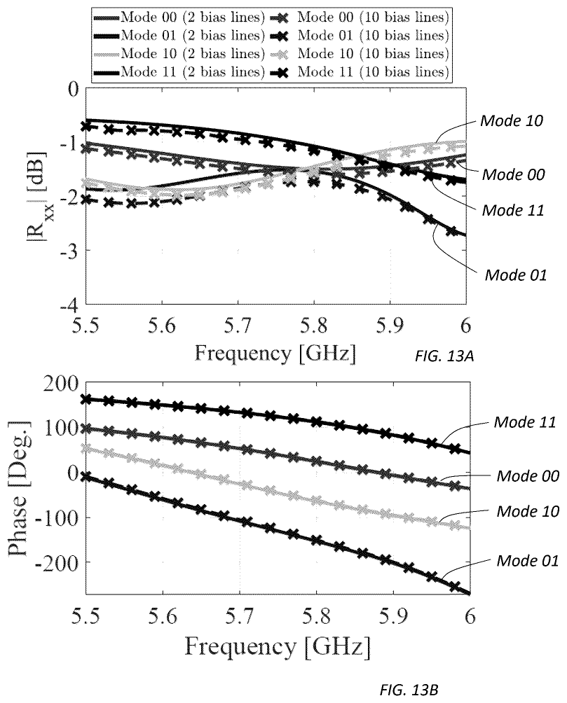

Besides the non-uniformity in the number of bias lines, the oblique incidence angle is another factor that must be considered during the design process. To examine its impact on the unit cell's electromagnetic response, the reflection characteristics were simulated under an oblique incidence angle of 30° for both TE and TM polarizations, considering two different bias line scenarios. Referring to FIGS. 12A, 12B, 13A, and 13B, the reflection responses of the proposed unit cell under TE and TM modes, respectively, are illustrated. When the incidence angle increases to 30°, the magnitudes of the reflection coefficients for all four modes exhibit a slight reduction but remain above −3 dB. Meanwhile, the phase distinctions among the four modes are preserved relative to the normal incidence case (0°). It is also observed that the phase response remains consistent regardless of the number of bias lines crossing the unit cell. These findings indicate that the proposed unit cell exhibits low sensitivity to oblique incidence angles. However, in practical array implementations, unit cells located near the array edges may experience more extreme incidence angles, leading to reduced reflection magnitudes, consequently degrading the overall performance of the RRA.

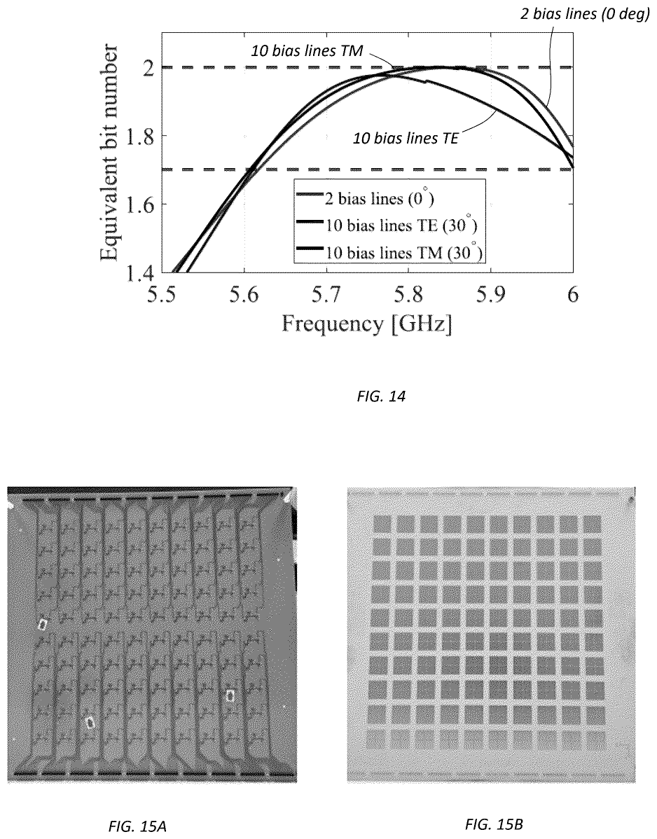

To quantify the phase resolution and compare different simulation scenarios, the equivalent bit number method was applied, following the approach described in the literature. Referring to FIG. 14, the resulting equivalent bit numbers for the proposed unit cell under three distinct scenarios are presented: (i) normal incidence with a 2-bias-line configuration, (ii) an oblique incidence angle of 30° with a 10-bias-line configuration under TE polarization, and (iii) the same oblique configuration under TM polarization. A threshold of 1.7 bits is adopted to determine whether the unit cell satisfies the 2-bit phase quantization criterion. Under this condition, the resulting 2-bit bandwidths for all three scenarios are found to exhibit identical phase resolution bandwidths of 6.6% (5.62-6.00 GHz).

Full-wave simulations predict that the proposed unit cell achieves 2-bit phase resolution within a 6.6% fractional bandwidth. Simulation results demonstrate an operating bandwidth of 6.6%, within which the phase resolution exceeds 1.7 bits and the reflection coefficient remains better than −2 dB.

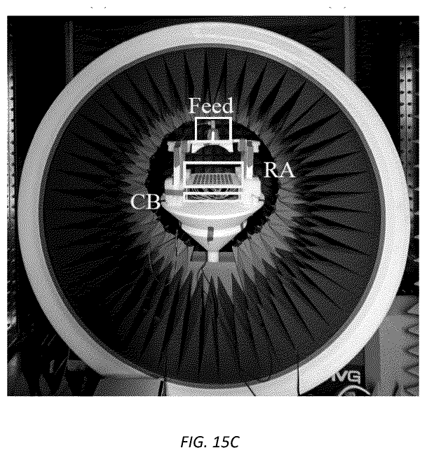

Referring to FIGS. 15A, 15B, and 15C, photographs of the fabricated prototype are shown. The bottom view and top view of the fabricated RRA are shown in FIGS. 15A and 13(b), respectively. The prototype was fabricated using standard printed circuit board (PCB) manufacturing techniques using Rogers RO4003C substrates bonded together by layers of Rogers RO4450F prepreg.

We characterized radiation patterns of the fabricated phase array using a near-field spherical measurement system. Referring to FIG. 15C, a measurement setup 800 for characterizing radiation patterns of the fabricated prototype is shown placed inside an anechoic chamber. A Styrofoam fixture was utilized to position the feed antenna at the specified focal distance and to correctly align its E-plane relative to the reflectarray during the measurements.

Referring to FIGS. 16A and 16B, comparison between simulated and measured radiation patterns in the E-plane for beam directions of (θ₀=0°, φ₀=0°) and (θ₀=15°, φ₀=0°) at 5.8 GHz, respectively, are presented. As shown in FIG. 16A, the pencil beam directed toward broadside exhibits good agreement between simulation and measurement. The measured realized gain is 19.12 dBi, which closely matches the simulated value of 19.2 dBi. Measurement results, shown in the figures, demonstrate effective beam scanning over a ±45°range in both the H-and E-planes, across a frequency range of 5.6-6 GHz. For the off-broadside direction (θ₀=15°, φ₀=0°), the measured realized gain decreases to 17.87 dBi, compared to 18.44 dBi in simulation. In both cases, the cross-polarization levels remain below −10 dB, and the sidelobe levels are −13.71 dB and −12.42 dB, respectively.

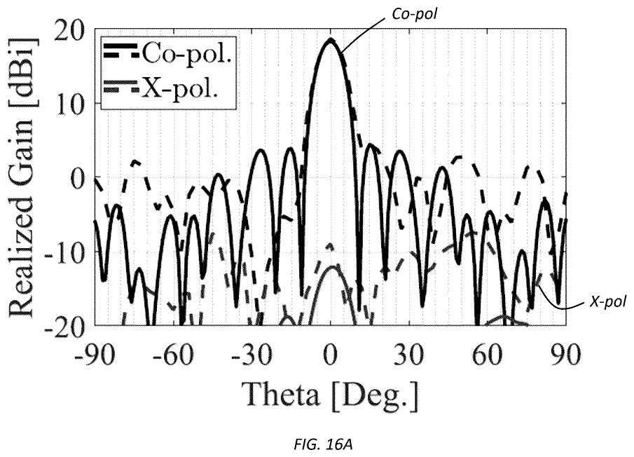

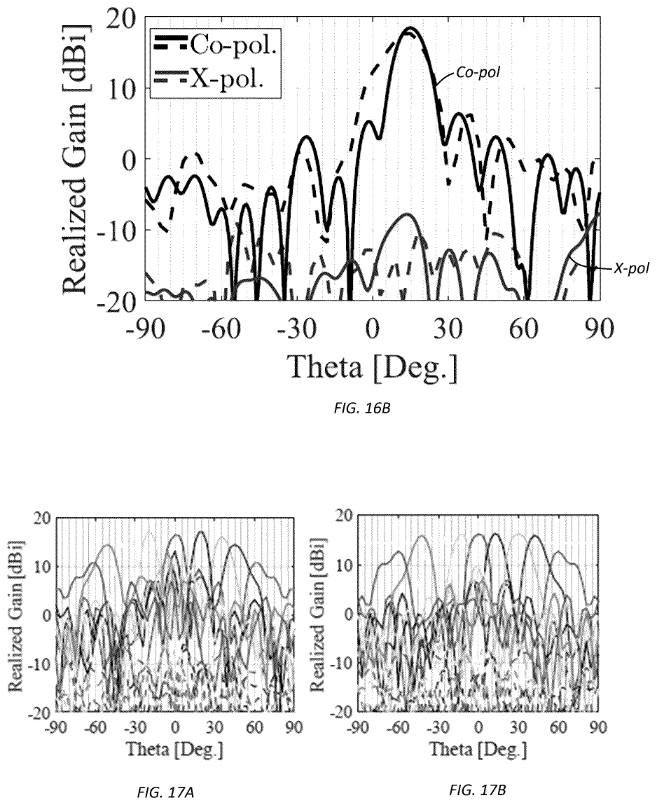

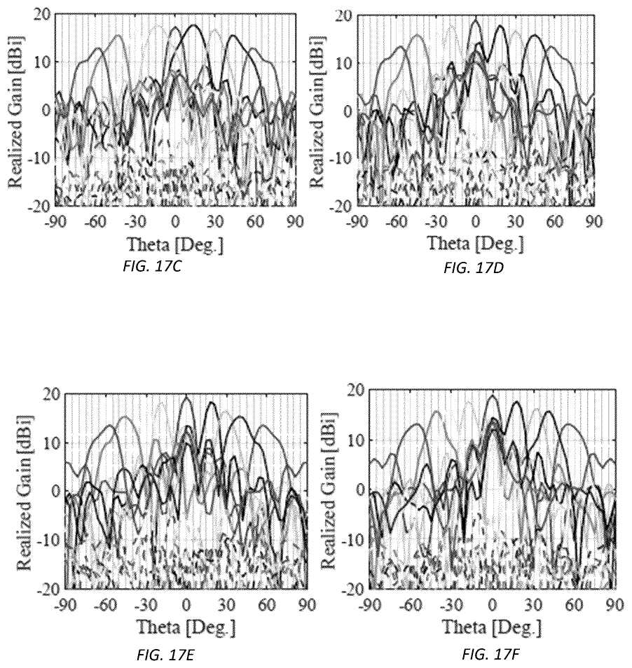

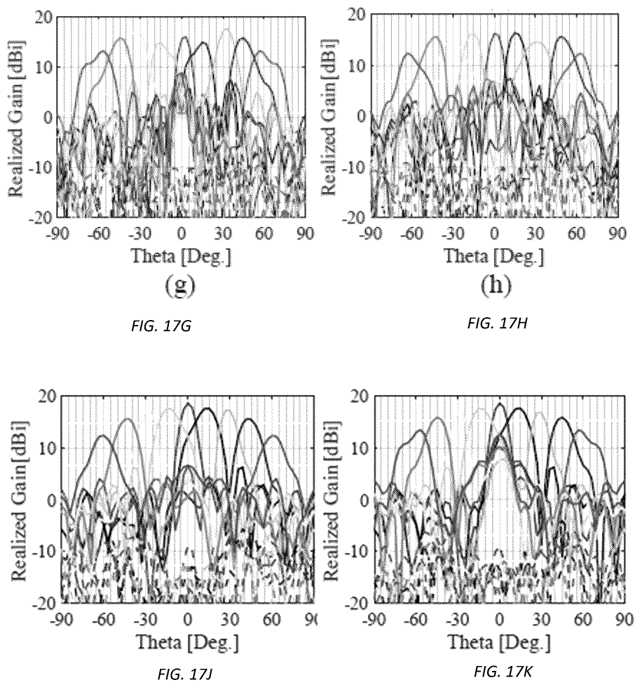

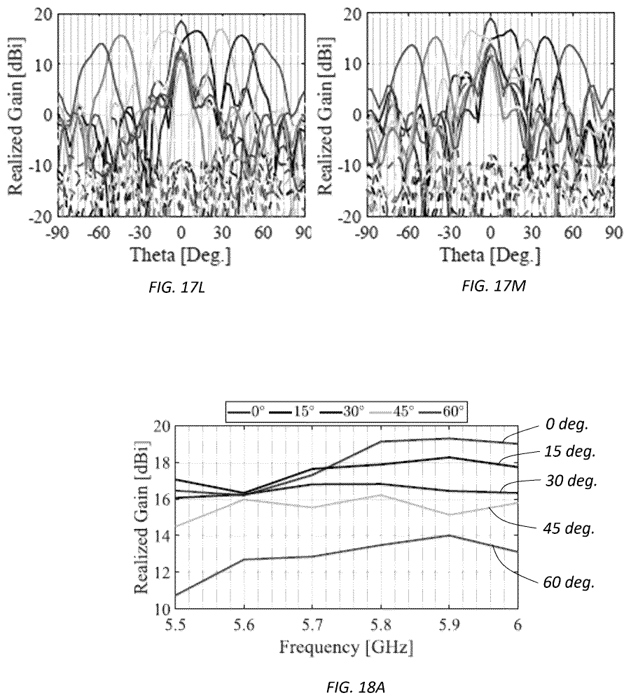

The radiation patterns of the RRA were measured across a frequency range of 5.5 to 6 GHz with an increment of 0.1 GHz. At each frequency point, the reflectarray was configured to scan the beam from θ₀=−60° to θ₀=60° in both φ₀=0° and φ₀=90°, with a uniform angular spacing of 15°. Referring to FIG. 17, measured co-polarized and cross-polarized radiation patterns of the reflectarray antenna for different frequencies are illustrated, including (A)-(F) E-plane patterns and (G)-(M) H-plane patterns at 5.5 GHz, 5.6 GHz, 5.7 GHz, 5.8 GHz, 5.9 GHz, and 6.0 GHz, respectively.

At 5.8 GHz, the measured peak gains of the reflectarray in the E-plane are 19.12, 17.87, 16.81, 16.21, and 13.48 dBi for scan angles θ₀=0°, 15°, 30°, 45°, and 60°, respectively. In the H-plane, the corresponding measured peak gains are 18.64, 17.65, 16.84, 15.70, and 13.40 dBi for the five scan angles. The maximum gain, achieved at broadside (e.g., for a scan angle of 0°), is 19 dBi, corresponding to a maximum aperture efficiency of approximately 26%. The measured realized gain is 19.12 dBi.

Furthermore, the cross-polarization levels remain below −10 dB across the 0°-60° scan range, with measured values of −40, −29, −31.8, −31.5, and −17.5 dBi in the E-plane, and −27, −27.6, −36.8, −19.7, and −24.4 dBi in the H-plane. It is also observed that the sidelobe levels tend to increase at larger scan angles. Specifically, the sidelobe levels are approximately −5 dB for the 30°and 45°scan angles within the 5.8 to 6 GHz frequency range in both the E-and H-planes, while remaining below −10 dBi for scan angles from 0°to 45°at other measured frequencies. This performance degradation at large scan angles can be attributed to several factors: (1) the reduction in reflection magnitudes of edge unit cells caused by oblique incidence and the non-uniform distribution of bias lines crossing each unit cell; (2) imperfections in the RF chokes used for biasing networks; (3) fabrication tolerances, such as bending and twisting of the multilayer PCB; and (4) external influences from the measurement setup, including cable routing and control board connections.

Referring to FIGS. 18A and 18B, the measured peak gains across frequency and scan angles in the E- and H-planes, respectively, are summarized. The fabricated RRA demonstrates effective beam-scanning performance over the 0°-60° range. In the E-plane, the maximum realized gain of 19.26 dBi is achieved at 5.9 GHz, while in the H-plane, the peak gain reaches 19.04 dBi at 6.0 GHz.

From the realized gain, the aperture efficiency is calculated by the following equation:

$${η}_{a p} ( {θ}_{0} ) = ( 4 π \times {A}_{p h y s} \times cos {θ}_{0} ) / ( {λ}^{2} \times G ) \qquad ( Eq . 4 )$$

where A_{phys} is the physical aperture area, G is the measured gain, and λ is the wavelength of the measurement frequency.

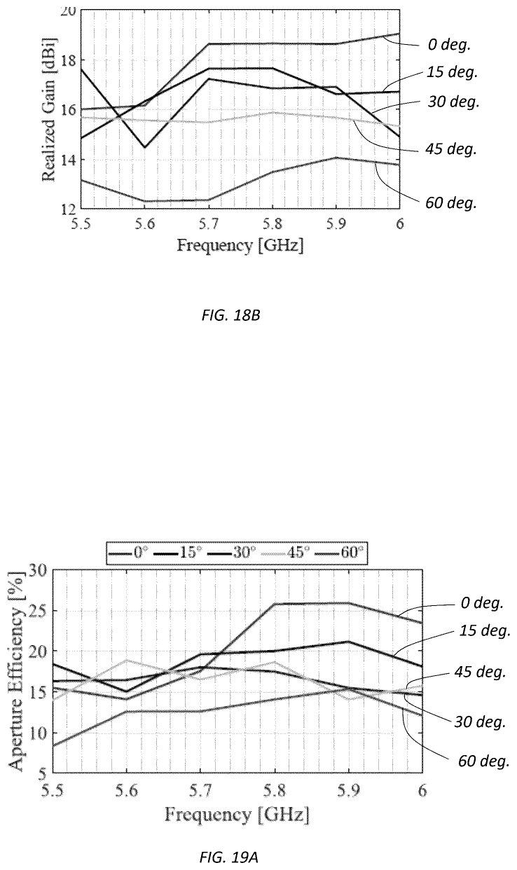

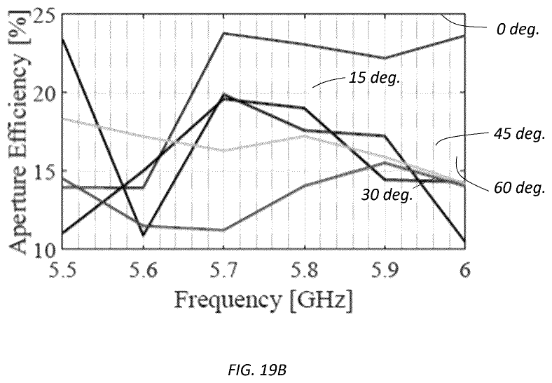

Referring to FIGS. 19A and 19B, the measured aperture efficiencies of the RRA in the E-and H-planes, respectively, are shown as functions of frequency and scan angle (from 0° to 60°). These efficiencies are derived from the realized gains measured over the 5.5-6.0 GHz frequency range. Across all scan angles, the measured aperture efficiency ranges from 9% to 26% in the E-plane and from 11% to 24% in the H-plane. The maximum efficiency of 26% is observed at 5.8 GHz and 5.9 GHz in the E-plane, while in the H-plane, a peak efficiency of 24% is achieved at 5.7 GHz. At 5.8 GHz, the RRA achieves a peak aperture efficiency of 26%. Measurement results confirm that the fabricated reflectarray enables wideband beam steering over a ±45° angular range, achieving a peak aperture efficiency of 26% at 5.8 GHz.

During the measurements, the mode assignment for each unit cell of the array was determined using equation (3), and the reflection phase φ_{ref}(xᵢ, yᵢ) in equation (1) was adjusted by adding a compensation term Δφ_{ref}. However, fabrication tolerances—particularly those arising from the multilayer stack-up—introduced distortions. Specifically, the RRA board exhibited a warping and twisting tolerance of 1.5% as specified by the manufacturer, which exceeds the typical design limit of 0.75%. To mitigate the impact of such fabrication-induced errors, an optimization algorithm (e.g., Genetic algorithm) should be employed to fine-tune the phase state distribution across the array, thereby improving the realized beam quality and steering performance.

Having described various systems, devices, and methods, certain aspects can include, but are not limited to:

In a first aspect, a reflectarray antenna element comprises: a first dielectric layer including a top surface and a bottom surface, wherein the first dielectric layer is formed of a first dielectric material; a conductive ground layer mounted to the top surface of the first dielectric layer, wherein the conductive ground layer includes an aperture formed therethrough, wherein the conductive ground layer is formed of a first conductive material; a second dielectric layer mounted to the conductive ground layer opposite the first dielectric layer, wherein the second dielectric layer includes a top surface and a bottom surface, wherein the second dielectric layer is formed of a second dielectric material; a radiating patch layer mounted to the top surface of the second dielectric layer, wherein the radiating patch layer comprises a plurality of patch elements arranged in a pattern with gaps therebetween, wherein the radiating patch layer is formed of a second conductive material; a delay line layer mounted to the bottom surface of the first dielectric layer, wherein the delay line layer comprises a first delay line and a second delay line positioned to couple electromagnetically with the aperture in the conductive ground layer; a first switch and a second switch mounted to the bottom surface of the first dielectric layer and electrically connected to the first delay line and the second delay line, wherein each of the first switch and the second switch is configured to be switchable between an ON state and an OFF state; wherein the first delay line is connected to an open-circuit termination and the second delay line is connected to a short-circuit termination; wherein the conductive ground layer is configured to reflect an electromagnetic wave incident on the radiating patch layer; wherein the aperture in the conductive ground layer is configured to provide electromagnetic coupling between the radiating patch layer and the delay line layer such that the incident electromagnetic wave excites an electromagnetic field that couples through the aperture to the first delay line and the second delay line; wherein a combination of states of the first switch and the second switch provides four distinct operating modes corresponding to four discrete phase shift values applied to a reflected electromagnetic wave relative to the incident electromagnetic wave, wherein the four discrete phase shift values comprise 0 degrees, 90 degrees, 180 degrees, and 270 degrees.

A second aspect can include the reflectarray antenna element of the first aspect, wherein the aperture in the conductive ground layer has an I-shaped configuration comprising a central rectangular slot extending in a first direction and two rectangular end slots extending in a second direction orthogonal to the first direction from opposite ends of the central rectangular slot.

A third aspect can include the reflectarray antenna element of the second aspect, wherein the I-shaped configuration is configured to achieve substantially uniform and linear electromagnetic field distribution along the aperture to enhance coupling with the first delay line and the second delay line.

A fourth aspect can include the reflectarray antenna element of any one of the first to third aspects, wherein the plurality of patch elements comprises four patch elements arranged in a two-by-two array.

A fifth aspect can include the reflectarray antenna element of the fourth aspect, wherein the gaps between the patch elements are configured to enhance coupling between the radiating patch layer and the delay line layer through the aperture.

A sixth aspect can include the reflectarray antenna element of any one of the first to fifth aspects, wherein the first switch and the second switch each comprise a PIN diode.

A seventh aspect can include the reflectarray antenna element of the sixth aspect, wherein each PIN diode comprises a MACOM MA4AGFCP910 PIN diode.

An eighth aspect can include the reflectarray antenna element of the sixth aspect, wherein each PIN diode has a forward-bias state corresponding to the ON state and a reverse-bias state corresponding to the OFF state.

A ninth aspect can include the reflectarray antenna element of any one of the first to eighth aspects, wherein the first delay line and the second delay line are electrically connected to a microstrip line positioned to cross the aperture.

A tenth aspect can include the reflectarray antenna element of the ninth aspect, wherein the first switch connects the first delay line to the microstrip line when in the ON state, and the second switch connects the second delay line to the microstrip line when in the ON state.

An eleventh aspect can include the reflectarray antenna element of any one of the first to tenth aspects, wherein the first delay line comprises an open-ended stub having an electrical length of approximately 180 degrees at a center operating frequency, and the second delay line comprises a short-circuited stub having an electrical length of approximately 90 degrees at the center operating frequency.

A twelfth aspect can include the reflectarray antenna element of any one of the first to eleventh aspects, further comprising fan-shaped stubs provided at an end of each of the first delay line and the second delay line to provide impedance tuning.

A thirteenth aspect can include the reflectarray antenna element of any one of the first to twelfth aspects, wherein the reflectarray antenna element has an operating bandwidth of at least 6 percent, wherein the operating bandwidth is defined by reflection coefficients of the four distinct operating modes being greater than or equal to −2 dB and phase resolution being greater than or equal to 1.7 bits.

A fourteenth aspect can include the reflectarray antenna element of the thirteenth aspect, wherein the operating bandwidth is 6.6 percent.

A fifteenth aspect can include the reflectarray antenna element of any one of the first to fourteenth aspects, wherein the first dielectric material comprises Rogers RO4003C laminate material having a dielectric constant of approximately 3.55 and a loss tangent of approximately 0.0027.

A sixteenth aspect can include the reflectarray antenna element of any one of the first to fifteenth aspects, wherein the second dielectric material comprises Rogers RO4003C substrates bonded together by layers of Rogers RO4450F prepreg having a dielectric constant of approximately 3.8 and a loss tangent of approximately 0.004.

A seventeenth aspect can include the reflectarray antenna element of any one of the first to sixteenth aspects, wherein the first dielectric layer has a thickness of approximately 1.52 mm, and the second dielectric layer has a total thickness of approximately 1.82 mm.

An eighteenth aspect can include the reflectarray antenna element of any one of the first to seventeenth aspects, wherein the reflectarray antenna element has lateral dimensions of approximately 26 mm by 26 mm to form a substantially square unit cell.

A nineteenth aspect can include the reflectarray antenna element of any one of the first to eighteenth aspects, further comprising bias circuitry comprising: inductors connected in series with the first switch and the second switch to provide DC bias while blocking radio frequency signals; and capacitors connected in parallel to provide AC coupling while blocking DC bias voltages.

A twentieth aspect can include the reflectarray antenna element of the nineteenth aspect, wherein the inductors comprise 7 nH inductors and the capacitors comprise 2 pF capacitors.

A twenty first aspect can include the reflectarray antenna element of the nineteenth aspect, further comprising series resistors of approximately 200 ohms inserted in bias lines to limit forward current of each switch to approximately 10 mA.

In a twenty second aspect, a reconfigurable reflectarray antenna system comprises: a feed antenna configured to generate an incident electromagnetic wave having a first polarization; a reflective array surface comprising a plurality of reflectarray antenna elements arranged in a two-dimensional array, wherein each reflectarray antenna element comprises: a first dielectric layer including a top surface and a bottom surface; a conductive ground layer mounted to the top surface of the first dielectric layer and including an aperture formed therethrough; a second dielectric layer mounted to the conductive ground layer opposite the first dielectric layer; a radiating patch layer mounted to a top surface of the second dielectric layer and comprising a plurality of patch elements with gaps therebetween; a delay line layer mounted to the bottom surface of the first dielectric layer and comprising a first delay line and a second delay line positioned to couple electromagnetically with the aperture; a first switch and a second switch electrically connected to the first delay line and the second delay line; wherein the first delay line is connected to an open-circuit termination and the second delay line is connected to a short-circuit termination; a control system operatively connected to the first switch and the second switch of each reflectarray antenna element, wherein the control system is configured to independently control states of the first switch and the second switch of each reflectarray antenna element to provide a selected phase shift distribution across the reflective array surface; wherein the feed antenna is positioned at a focal distance from the reflective array surface; wherein each reflectarray antenna element is configured to reflect the incident electromagnetic wave with one of four discrete phase shift values based on states of the first switch and the second switch; wherein the selected phase shift distribution is configured to collimate the incident electromagnetic wave into a main beam directed at a selected scan angle relative to a boresight direction of the reconfigurable reflectarray antenna system.

A twenty third aspect can include the reconfigurable reflectarray antenna system of the twenty second aspect, wherein the plurality of reflectarray antenna elements comprises a 10 -by-10 array of unit cells covering an aperture area of approximately 260 mm by 260 mm.

A twenty fourth aspect can include the reconfigurable reflectarray antenna system of the twenty second or twenty third aspect, wherein the focal distance is approximately 270 mm.

A twenty fifth aspect can include the reconfigurable reflectarray antenna system of any one of the twenty second to twenty fourth aspects, wherein the feed antenna comprises a horn antenna having an aperture dimension of approximately 4 cm by 4 cm, with an E-plane oriented along a predetermined axis.

A twenty sixth aspect can include the reconfigurable reflectarray antenna system of any one of the twenty second to twenty fifth aspects, wherein the reconfigurable reflectarray antenna system is configured to provide beam scanning over a range of at least ±60 degrees in both an H-plane and an E-plane across a frequency range of 5.5 GHz to 6.0 GHz.

A twenty seventh aspect can include the reconfigurable reflectarray antenna system of any one of the twenty second to twenty sixth aspects, wherein the system supports beam scanning up to ±45 degrees with a 3-dB gain reduction across the scanned angles in both an E-plane and an H-plane.

A twenty eighth aspect can include the reconfigurable reflectarray antenna system of any one of the twenty second to twenty seventh aspects, wherein the reconfigurable reflectarray antenna system achieves a maximum realized gain of at least 19 dBi at a broadside scan angle of 0 degrees.

A twenty ninth aspect can include the reconfigurable reflectarray antenna system of the twenty eighth aspect, wherein the maximum realized gain is 19.12 dBi at 5.8 GHz.

A thirtieth aspect can include the reconfigurable reflectarray antenna system of any one of the twenty second to twenty ninth aspects, wherein an aperture efficiency at a broadside scan angle is at least 25 percent.

A thirty first aspect can include the reconfigurable reflectarray antenna system of the thirtieth aspect, wherein a peak aperture efficiency is 26 percent at 5.8 GHz.

A thirty second aspect can include the reconfigurable reflectarray antenna system of any one of the twenty second to thirty first aspects, wherein measured aperture efficiency ranges from 9 percent to 26 percent in an E-plane and from 11 percent to 24 percent in an H-plane across scan angles from 0 degrees to 60 degrees over a 5.5-6.0 GHz frequency range.

A thirty third aspect can include the reconfigurable reflectarray antenna system of any one of the twenty second to thirty second aspects, wherein cross-polarization levels remain below −10 dB across a 0-degree to 60-degree scan range.

A thirty fourth aspect can include the reconfigurable reflectarray antenna system of any one of the twenty second to thirty third aspects, wherein the control system comprises: a field-programmable gate array (FPGA) board; a plurality of shift registers; a plurality of D-type flip-flops; and a row-select decoder.

A thirty fifth aspect can include the reconfigurable reflectarray antenna system of the thirty fourth aspect, wherein the FPGA board supplies digital bias levels of 0 V for reverse bias and 3.3 V for forward bias to the shift registers, with resulting outputs latched by the D-type flip-flops and routed to corresponding switches.

A thirty sixth aspect can include the reconfigurable reflectarray antenna system of the thirty fourth or thirty fifth aspect, wherein the FPGA board updates the array on a row-by-row basis, each row containing ten switches, with serial data representing desired bias states clocked into the shift registers and propagated through the D-type flip-flops.

A thirty seventh aspect can include the reconfigurable reflectarray antenna system of any one of the thirty fourth to thirty sixth aspects, wherein the control system refreshes all switches in approximately 8 microseconds when driven by a 100 MHz clock, representing a switching time from one beam to another.

A thirty eighth aspect can include the reconfigurable reflectarray antenna system of any one of the twenty second to thirty seventh aspects, wherein each switch is forward-biased at approximately 1.33 V and 10 mA, resulting in a total power dissipation of approximately 2.7 W when all switches are in an ON state.

In a thirty ninth aspect, a method of operating a reconfigurable reflectarray antenna comprises: providing a reflective array surface comprising a plurality of reflectarray antenna elements, wherein each reflectarray antenna element comprises: a first dielectric layer; a conductive ground layer mounted to the first dielectric layer and including an aperture; a second dielectric layer mounted to the conductive ground layer; a radiating patch layer mounted to the second dielectric layer; a delay line layer mounted to the first dielectric layer and comprising a first delay line connected to an open-circuit termination and a second delay line connected to a short-circuit termination; and a first switch and a second switch electrically connected to the first delay line and the second delay line; generating an incident electromagnetic wave using a feed antenna positioned at a focal distance from the reflective array surface; for each reflectarray antenna element: determining a required reflection phase shift based on a phase of the incident electromagnetic wave at a center of the reflectarray antenna element and a desired outgoing phase to direct a main beam at a selected scan angle; quantizing the required reflection phase shift into one of four discrete phase shift levels corresponding to four operating modes; and setting states of the first switch and the second switch based on the quantized phase shift level to establish the corresponding operating mode; reflecting the incident electromagnetic wave from the reflective array surface to form a collimated beam directed at the selected scan angle.

A fortieth aspect can include the method of the thirty ninth aspect, wherein the four operating modes correspond to combinations of switch states wherein: a first mode has both switches in an OFF state corresponding to a 0-degree phase shift; a second mode has the first switch OFF and the second switch ON corresponding to a 270-degree phase shift; a third mode has the first switch ON and the second switch OFF corresponding to a 90-degree phase shift; and a fourth mode has both switches in an ON state corresponding to a 180-degree phase shift.

In a forty first aspect, a reconfigurable reflectarray antenna (RRA) comprises: a reflection surface comprising a plurality of elements, wherein each element of the plurality of elements is configured to reflect an incident wave with a phase shift; wherein each element of the plurality of elements is a 2-bit unit cell with 2 single-pole single-throw (SPST) switches.

A forty second aspect can include the RRA of the forty first aspect, wherein each element comprises a radiating patch layer, an aperture layer, and a delay line layer, wherein the aperture layer is disposed between the radiating patch layer and the delay line layer.

A forty third aspect can include the RRA of the forty second aspect, wherein the 2 SPST switches are in the delay line layer.

A forty fourth aspect can include the RRA of the forty second or forty third aspect, wherein the radiating patch layer is divided into a plurality of patches with a gap in between.

A forty fifth aspect can include the RRA of any one of the forty second to forty fourth aspects, wherein the aperture layer comprises an I-shaped or H-shaped aperture.

A forty sixth aspect can include the RRA of any one of the forty first to forty fifth aspects, wherein the reflection surface is flat.

A forty seventh aspect can include the RRA of any one of the forty first to forty sixth aspects, wherein the phase shift is between 0 degrees to 360 degrees.

A forty eighth aspect can include the RRA of any one of the forty first to forty seventh aspects, wherein the RRA has a 2-bit phase shift bandwidth of greater than 3%, greater than 4%, or greater than 5%.

A forty ninth aspect can include the RRA of any one of the forty first to forty eighth aspects, wherein the RRA has an effective beam scanning over a plus or minus 45 degree range in both the H-plane and E-plane over a frequency range of 5.5-6 GHz.

A fiftieth aspect can include the RRA of any one of the forty first to forty ninth aspects, wherein a gain at a scan angle of 0 degrees is at least about 15 dBi, at least about 17 dBi, at least about 18 dBi, at least about 19 dBi, or at least about 19.3 dBi.

For purposes of the disclosure herein, the term “comprising” includes “consisting” or “consisting essentially of.” Further, for purposes of the disclosure herein, the term “including”

includes “comprising,” “consisting,” or “consisting essentially of.”

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the aspects of the present invention. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein.

While embodiments of the invention have been shown and described, modifications thereof can be made by one skilled in the art without departing from the spirit and teachings of the invention. Many variations and modifications of the subject matter disclosed herein are possible and are within the scope of the disclosed subject matter. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc. ; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

1. A reflectarray antenna element comprising:
a first dielectric layer;
a conductive ground layer mounted to the first dielectric layer and including an aperture formed therethrough;
a second dielectric layer mounted to the conductive ground layer;
a radiating patch layer mounted to the second dielectric layer;
a delay line layer mounted to the first dielectric layer and comprising a first delay line connected to an open-circuit termination and a second delay line connected to a short-circuit termination, wherein the first delay line and the second delay line are positioned to couple electromagnetically with the aperture; and
a first switch and a second switch electrically connected to the first delay line and the second delay line, wherein each switch is switchable between an ON state and an OFF state.

2. The reflectarray antenna element of claim 1, wherein a combination of states of the first switch and the second switch provides four distinct operating modes corresponding to four discrete phase shift values applied to a reflected electromagnetic wave relative to an incident electromagnetic wave, wherein the four discrete phase shift values comprise approximately 0 degrees, 90 degrees, 180 degrees, and 270 degrees.

3. The reflectarray antenna element of claim 1, wherein the aperture is configured to provide electromagnetic coupling between the radiating patch layer and the delay line layer such that the incident electromagnetic wave excites an electromagnetic field that couples through the aperture to the first delay line and the second delay line.

4. The reflectarray antenna element of claim 1, wherein the radiating patch layer comprises a plurality of patch elements arranged with gaps therebetween.

5. The reflectarray antenna element of claim 1, wherein the first switch and the second switch each comprise a PIN diode.

6. The reflectarray antenna element of claim 1, wherein the first delay line and the second delay line are electrically connected to a microstrip line positioned to couple with the aperture, and wherein the first switch connects the first delay line to the microstrip line when in the ON state, and the second switch connects the second delay line to the microstrip line when in the ON state.

7. The reflectarray antenna element of claim 1, wherein the reflectarray antenna element has an operating bandwidth of at least 5 percent, wherein the operating bandwidth is defined by reflection coefficients of the four distinct operating modes being greater than or equal to −2 dB and phase resolution being greater than or equal to 1.7 bits.

8. A reconfigurable reflectarray antenna system comprising:
a feed antenna configured to generate an incident electromagnetic wave;
a reflective array surface comprising a plurality of reflectarray antenna elements arranged in a two-dimensional array, wherein each reflectarray antenna element comprises:
a conductive ground layer including an aperture formed therethrough;
dielectric layers mounted to the conductive ground layer;
a radiating patch layer;
a delay line layer comprising a first delay line connected to an open-circuit termination and a second delay line connected to a short-circuit termination, wherein the delay lines are positioned to couple electromagnetically with the aperture;
a first switch and a second switch electrically connected to the first delay line and the second delay line; and
a control system operatively connected to the first switch and the second switch of each reflectarray antenna element and configured to independently control states thereof to provide a selected phase shift distribution across the reflective array surface.

9. The reconfigurable reflectarray antenna system of claim 8, wherein the feed antenna is positioned at a focal distance from the reflective array surface.

10. The reconfigurable reflectarray antenna system of claim 8, wherein each reflectarray antenna element is configured to reflect the incident electromagnetic wave with one of four discrete phase shift values based on states of the first switch and the second switch, wherein the selected phase shift distribution is configured to collimate the incident electromagnetic wave into a main beam directed at a selected scan angle.

11. The reconfigurable reflectarray antenna system of claim 8, wherein the reconfigurable reflectarray antenna system achieves a maximum realized gain of at least 19 dBi at a broadside scan angle.

12. The reconfigurable reflectarray antenna system of claim 8, wherein the control system comprises a microcontroller with a plurality of input/output pins configured to independently control bias states of the first switch and the second switch of each reflectarray antenna element.

13. The reconfigurable reflectarray antenna system of claim 8, wherein the reconfigurable reflectarray antenna system is configured to provide beam scanning over a range of at least ±45 degrees in both an H-plane and an E-plane.

14. The reconfigurable reflectarray antenna system of claim 8, wherein each reflectarray antenna element uses only two switches to achieve four discrete phase shift values for 2-bit phase quantization.

15. A method of operating a reconfigurable reflectarray antenna, the method comprising:
providing a reflective array surface comprising a plurality of reflectarray antenna elements, wherein each reflectarray antenna element comprises a delay line layer with a first delay line connected to an open-circuit termination and a second delay line connected to a short-circuit termination, and a first switch and a second switch electrically connected to the first delay line and the second delay line;
generating an incident electromagnetic wave using a feed antenna;
for each reflectarray antenna element, determining a reflection phase shift based on a phase of the incident electromagnetic wave at the reflectarray antenna element and a desired outgoing phase to direct a main beam at a selected scan angle;
quantizing the reflection phase shift into one of four discrete phase shift levels corresponding to four operating modes;
setting states of the first switch and the second switch of each reflectarray antenna element based on the quantized phase shift level; and
reflecting the incident electromagnetic wave from the reflective array surface to form a beam directed at the selected scan angle.

16. The method of claim 15, wherein the four operating modes correspond to combinations of switch states wherein different combinations of ON and OFF states of the first switch and the second switch produce phase shifts of substantially 0 degrees, 90 degrees, 180 degrees, and 270 degrees.

17. The method of claim 15, wherein determining the reflection phase shift satisfies the relationship:
$${φ}_{ref} ( {x}_{i} , {y}_{i} ) = {φ}_{out} ( {x}_{i} , {y}_{i} ) - {φ}_{inc} ( {x}_{i} , {y}_{i} ) ,$$
where φ_{ref} is the required reflection phase shift, φₒᵤₜ is the desired outgoing phase, φ_{inc} is the phase of the incident electromagnetic wave, and (xᵢ, yᵢ) are coordinates of the reflectarray antenna element.

18. The method of claim 17, wherein the desired outgoing phase is based on the selected scan angle (θ₀, φ₀) and satisfies the relationship:
$${φ}_{out} ( {x}_{i} , {y}_{i} ) = - ( 2 π / λ ) \times {r}_{i} \times sin ( {θ}_{0} ) \times cos ( {φ}_{i} - {φ}_{0} ) ,$$
where λ is wavelength, rᵢ is radial distance from an array center to the reflectarray antenna element, and φᵢ is azimuthal angle.

19. The method of claim 15, wherein quantizing the reflection phase shift comprises assigning one of four modes based on which discrete phase shift level is closest to the reflection phase shift.

20. The method of claim 15, wherein the method achieves beam scanning over a range of at least ±45 degrees with less than 3-dB gain reduction across scanned angles.
